(19) United States
(12) Patent Application Publication
(10) Pub. No.: US 2019/0244575 A1
(43) Pub. Date: Aug. 8, 2019

(54) DISPLAY APPARATUS AND DISPLAY SYSTEM

(71) Applicant: SHARP KABUSHIKI KAISHA, Sakai City (JP)

(72) Inventors: SHIGEYUKI AKASE, Sakai City (JP); TSUYOSHI ONO, Sakai City (JP); HIROYOSHI HIGASHISAKA, Sakai City (JP)

(21) Appl. No.: 16/263,288

(22) Filed: Jan. 31, 2019

(30) Foreign Application Priority Data
Feb. 7, 2018 (JP) 2018-020313

(51) Int. Cl. G09G 3/36; G09G 3/00

(52) U.S. Cl. CPC G09G 3/3648; G09G 3/006; G09G 2300/08; G09G 2300/0452; G09G 2310/0264

(57) ABSTRACT

A display apparatus includes: a plurality of pixel sections, each having a pixel element, to which image display signals are inputted; and test terminals via which the image display signals and test signals that are inputted from an outside source are selectively inputted to the plurality of pixel sections. A display apparatus includes: a plurality of pixel sections each having a pixel element; driver circuit sections that input image display signals to the plurality of pixel sections; and test terminals via which the image display signals and test signals that are inputted from an outside source are selectively inputted to the plurality of pixel sections, or the driver circuit sections generate test signals in accordance with test signals that are inputted from an outside source, and input the test signals thus generated to the plurality of pixel sections.

### BACKGROUND

### 1. Field

The present disclosure relates to a display apparatus and a display system.

### 2. Description of the Related Art

In a display apparatus, for example, driver circuit sections receive image data from an outside source, convert the image data into signals for use in image display on a plurality of pixel sections, and causes a plurality of pixels to be driven by drive circuits to display an image. In such a display apparatus, for example, drive circuits that drive pixel elements and the pixel elements are integrally formed, and the driver circuit sections are mounted in a later step. In this case, a failure/no-failure test to determine whether the display apparatus mounted with the drive circuits is good or bad and a failure/no-failure test to determine whether the driver circuit sections are good or bad are individually conducted, and after that, the driver circuit sections are mounted in the display apparatus mounted with the drive circuits. Then, as a final check, a display check test on each pixel element is carried out by use of image data that is inputted from an outside source and the driver circuit sections. That is, a display check test on each pixel element is carried out by actuating the driver circuit sections.

However, in such a display apparatus, a display check test on each pixel element cannot be carried out unless the driver circuit sections operate normally. That is, in a case where a pixel element does not perform intended operation when a display check test on the pixel element is carried out, it is impossible to identify whether there is a fault on the part of the pixel element or there is a fault on the part of the driver circuit sections or the drive circuits.

In this regard, Japanese Unexamined Patent Application Publication No. 2015-59781 discloses a technology for determining a fault by a PL inspection method that involves the use of PL (photoluminescence). However, the technology disclosed in Japanese Unexamined Patent Application Publication No. 2015-59781 requires components such as an LED light source, a power source, and a photographing section, complicating a configuration for determining a fault.

For example, in a display apparatus in which driver circuit sections and drive circuits that drive pixel elements (e.g. circuits on an identical substrate, or specifically, a silicon substrate; hereinafter sometimes referred to simply as “LSI circuit”) are integrally formed on a single chip or mounted in a later step and the pixel elements are bonded in a later step, it is difficult to do an operation test on the driver circuit sections and the drive circuits that the drive pixel elements as a single chip in an LSI state. This makes it necessary to carry out a display check on each pixel after having bonded the pixel elements in a later step. At this point in time, it is necessary to isolate the fault in the driver circuit sections and the fault in the driver circuits that drive the pixel elements from each other, and it is necessary to actuate the driver circuit sections in order to carry out a display check test.

Furthermore, in an LSI state, it is necessary to prepare a test probe for a terminal to which a pixel element of each of a plurality of pixels is connected, and a test on the drive circuits that drive the pixel elements is complicated and requires a large number of probes, thus incurring higher test costs.

For example, in a case where the pixel elements (or specifically, LEDs) are bonded to the LSI circuit, doing a display check test on the pixel elements requires carrying out a display check test by actuating the driver circuit sections with image data that is inputted from an outside source, and for that purpose, an expensive test facility to which image data can be inputted is necessary, incurring high costs. Further, since the inputting of image data involves the use of serial data input as typified by MIPI (registered trademark) (mobile industry processor interface), data input requires a large number of clocks and a longer test time, causing problems such as prolonged TAT (turnaround time) and increased test costs.

Further, it is costly, troublesome, and not feasible to carry out a display check test on pixel elements using an expensive tester each time in checking finished quality for the bonding step and each step subsequent to the bonding step.

It is desirable to provide a display apparatus and a display system that are simple in configuration and yet make it possible to easily carry out a display check with pixel elements driven.

### SUMMARY

According to a first of the disclosure, there is provided a display apparatus including: a plurality of pixel sections, each having a pixel element, to which image display signals are inputted; and test terminals via which the image display signals and test signals that are inputted from an outside source are selectively inputted to the plurality of pixel sections.

According to a second of the disclosure, there is provided a display apparatus including: a plurality of pixel sections each having a pixel element; driver circuit sections that input image display signals to the plurality of pixel sections; and test terminals via which the image display signals and test signals that are inputted from an outside source are selectively inputted to the plurality of pixel sections.

According to a third aspect of the disclosure, there is provided a display apparatus including a plurality of pixel sections each having a pixel element; and driver circuit sections that input image display signals to the plurality of pixel sections, wherein the driver circuit sections generate test signals in accordance with test signals that are inputted from an outside source, and input the test signals thus generated to the plurality of pixel sections.

According to an aspect of the disclosure, there is provided a display system including a display apparatus according to an aspect of the present disclosure.

### BRIEF DESCRIPTION OF THE DRAWINGS

FIG. 1 is a circuit diagram schematically showing a circuit configuration of a display apparatus according to an embodiment of the present disclosure;

FIG. 2 is a circuit diagram schematically showing the basic idea of the display apparatus according to the present embodiment;

FIG. 3 is an enlarged circuit diagram of the part of pixel sections and test terminal sections of a display apparatus according to a first embodiment;

FIG. 4 is an enlarged circuit diagram of the part of a pixel section of the circuit diagram shown in FIG. 3;

FIG. 5 is a block diagram showing the flow of signals in a first driver circuit section;

FIG. 6 is a block diagram showing the flow of signals in a second driver circuit section;

FIG. 7A is a circuit diagram showing an example of a circuit configuration of the display apparatus according to the first embodiment;

FIG. 7B is a circuit diagram showing another example of a circuit configuration of the display apparatus according to the first embodiment;

FIG. 7C is a circuit diagram showing still another example of a circuit configuration of the display apparatus according to the first embodiment;

FIG. 8A is a circuit diagram showing an example of a circuit configuration of a display apparatus according to a second embodiment;

FIG. 8B is an enlarged circuit diagram of a part of a gate-side sample hold memory circuit section of the display apparatus shown in FIG. 8A;

FIG. 8C is an enlarged circuit diagram of a part of a gate-side shift register circuit section of the display apparatus shown in FIG. 8A;

FIG. 9A is a circuit diagram showing another example of a circuit configuration of the display apparatus according to the second embodiment;

FIG. 9B is an enlarged circuit diagram of a part of a gate-side sample hold memory circuit section of the display apparatus shown in FIG. 9A;

FIG. 9C is an enlarged circuit diagram of a part of a gate-side shift register circuit section of the display apparatus shown in FIG. 9A;

FIG. 10A is a circuit diagram showing still another example of a circuit configuration of the display apparatus according to the second embodiment;

FIG. 10B is an enlarged circuit diagram of a part of a gate-side sample hold memory circuit section of the display apparatus shown in FIG. 10A;

FIG. 10C is an enlarged circuit diagram of a part of a gate-side shift register circuit section of the display apparatus shown in FIG. 10A;

FIG. 11A is a circuit diagram schematically showing a configuration of the part of a gate-side shift register circuit section in an example of a display apparatus according to a third embodiment;

FIG. 11B is a circuit diagram schematically showing a configuration of the part of a gate-side shift register circuit section in another example of a display apparatus according to the third embodiment;

FIG. 12A is an example of a timing chart of the gate-side shift register circuit section during normal operation;

FIG. 12B is an example of a timing chart of the gate-side shift register circuit section shown in FIG. 11A during test operation;

FIG. 12C is an example of a timing chart of the gate-side shift register circuit section shown in FIG. 11B during test operation;

FIG. 13A shows an example of an operation circuit of a discrimination section that discriminates between a normal signal and a selection signal;

FIG. 13B is an example of an operation chart of the discrimination section that discriminates between a normal signal and a selection signal;

FIG. 14A is a circuit diagram schematically showing a circuit configuration of a display apparatus including liquid crystal elements;

FIG. 14B is an enlarged circuit diagram of the part of pixel sections of the display apparatus including liquid crystal elements;

FIG. 14C is an enlarged circuit diagram of the part of a pixel section of the circuit diagram shown in FIG. 14B; and

FIGS. 15A to 15G are explanatory diagrams for explaining manufacturing steps of an example of a method for manufacturing a display apparatus.

### DESCRIPTION OF THE EMBODIMENTS

The following describes embodiments of the present disclosure with reference to the drawings. In the following description, identical components are given identical signs. The same applies to their names and functions. Accordingly, a detailed description of them is not repeated.

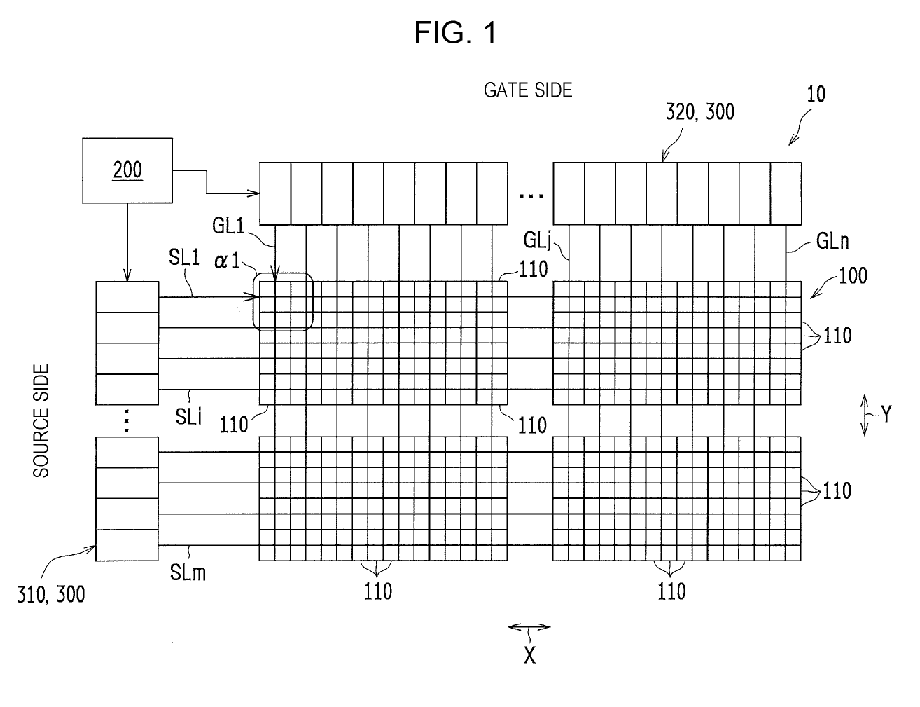

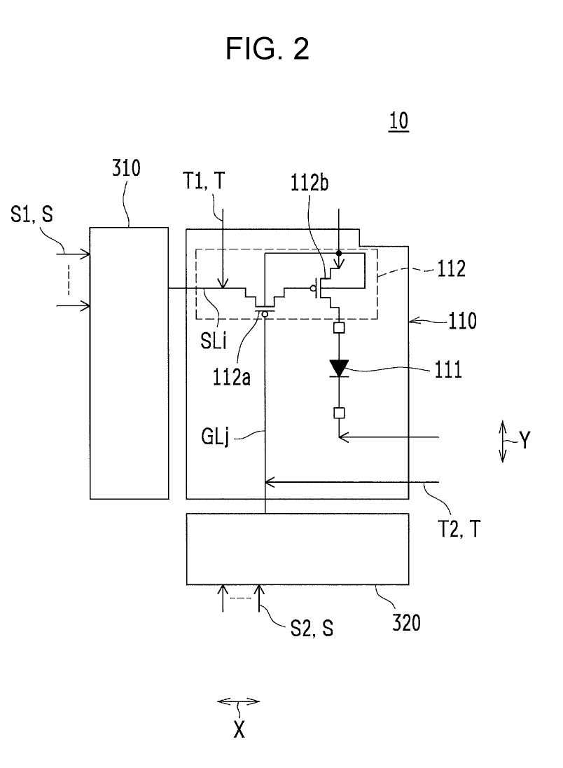

FIG. 1 is a circuit diagram schematically showing a circuit configuration of a display apparatus 10 according to an embodiment of the present disclosure. FIG. 2 is a circuit diagram schematically showing the basic idea of the display apparatus 10 according to the present embodiment. The display apparatus 10 includes a plurality of pixel sections 110 that are similar in configuration to one another. Accordingly, FIG. 2 shows one pixel section 110 of the plurality of pixel sections 110 of the display apparatus 10 as a representative.

As shown in FIGS. 1 and 2, the display apparatus 10 (display panel) includes a matrix of pixel elements 111 arranged side by side in a row-wise direction X and a column-wise direction Y. This example assumes that the pixel elements 111 are light-emitting elements (or specifically, light-emitting diodes).

The display apparatus 10 includes a plurality of pixel sections 110 including a plurality of pixel elements 111, respectively, and driver circuit sections 300 that input image display signals S (see FIG. 2) to the plurality of pixel sections 110. In particular, the display apparatus 10 includes a display section 100, a control section 200 (display control section), a first driver circuit section 310 (300), and a second driver circuit section 320 (300). The first driver circuit section 310 and the second driver circuit section 320 are each supplied with power from a power source circuit section (not illustrated). In this example, the first driver circuit section 310 includes source driver circuits, and the second driver circuit section 320 include gate driver circuits.

The source driver circuits and the gate driver circuits have a role to convert, into image display signals that determine the respective emission intensities of pixels, various types of signal into which image data inputted from an external image input apparatus has been converted by the control section 200.

The display section 100 is mounted with a plurality of (m×n) (where m and n are positive integers) pixel sections 110. The display section 100 is provided with m source wires (data lines) SL1 to SLm and n gate wires (scanning lines) GL1 to GLn. The pixel sections 110 are provided in correspondence with points of intersection between the m source wires SL1 to SLm and the n gate wires GL1 to GLn, respectively. In the display section 100, one pixel (in the case of a color display, one subpixel) is formed by one pixel section 110. FIG. 2 shows a pixel section 110 in the ith row and the jth column provided in correspondence with a point of intersection between a source wire SLi and a gate wire GLj (i=1 to m, j=1 to n). In this example, assuming that k is an integer of 1 or greater, pixels formed by pixel sections 110 in the (3×k−2)th row are pixels that correspond to red (R), pixels formed by pixel sections 110 in the (3×k−1)th row are pixels that correspond to green (G), and pixels formed by pixel sections 110 in the (3×k)th row are pixels that correspond to blue (B). In the case of such an arrangement of pixel sections 110, red (R), green (G), and blue (B) are arranged at regular intervals. The order of red, green, and blue is an example of a case where a display apparatus is made white, and any order of red, green, and blue will do. Further, it is also possible to add yellow (Y), cyan (C), and magenta (M). Further, as for a display apparatus that is not intended for use in full color, it is possible to use any single color or any combination of colors. Alternatively, a plurality of display colors may be arranged on an identical source wire SLi or gate wire GLi as typified by a Bayer arrangement.

As shown in FIG. 2, the pixel section 110 is constituted by a drive circuit 112 and a pixel element 111, and the drive circuit 112 includes a first drive element 112a (Nch or Pch transistor; in the example shown in FIG. 2, an Nch transistor is used) and a second drive element 112b (Nch or Pch transistor; in the example shown in FIG. 2, an Nch transistor is used). The first drive element 112a has its gate terminal connected to the gate wire GLj, and has its source terminal connected to the source wire SLi. The second drive element 112 has its gate terminal connected to a drain terminal of the first drive element 112a, and has its drain terminal connected to the pixel element 111. FIG. 2 is an example, and the drive circuit 112 needs only have a circuit configuration to be capable of controlling the drive of the pixel element 111 in response to a source signal and a gate signal. The drive circuit 112 may use both Nch and Pch, making the first drive element 112a a transfer gate at which Nch and Pch are connected in parallel makes it possible to transmit the voltage of the source wire SLi to the second drive element 112b with a minimum reduction. The second drive element 112b may also be connected to a source terminal of the pixel element ill. A combination of drive elements that controls a voltage or current that is applied to a pixel element by such a combination of drive elements is a drive circuit, and it is also possible to combine a plurality of transistors, capacitances, or resistances in order to make a threshold adjustment to the pixel element.

The first driver circuit section 310 and the second driver circuit section 320 serve to control the drive circuits 112. The first driver circuit section 310 inputs a first image display signal S1 to each row of pixel sections 110. The second driver circuit section 320 inputs a second image display signal S2 to each column of pixel sections 110.

Moreover, the display section 100 selectively inputs, to the plurality of pixel sections 110, the image display signals S and test signals T (see FIG. 2) that are inputted from an outside source to the plurality of pixel sections 110 without passing through the driver circuit sections 300.

### First Embodiment

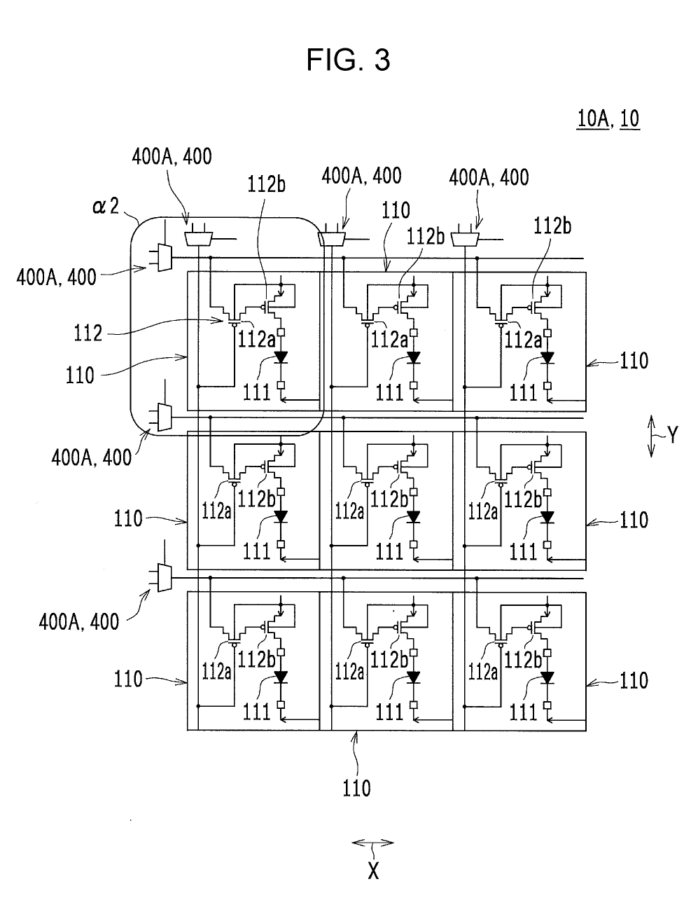

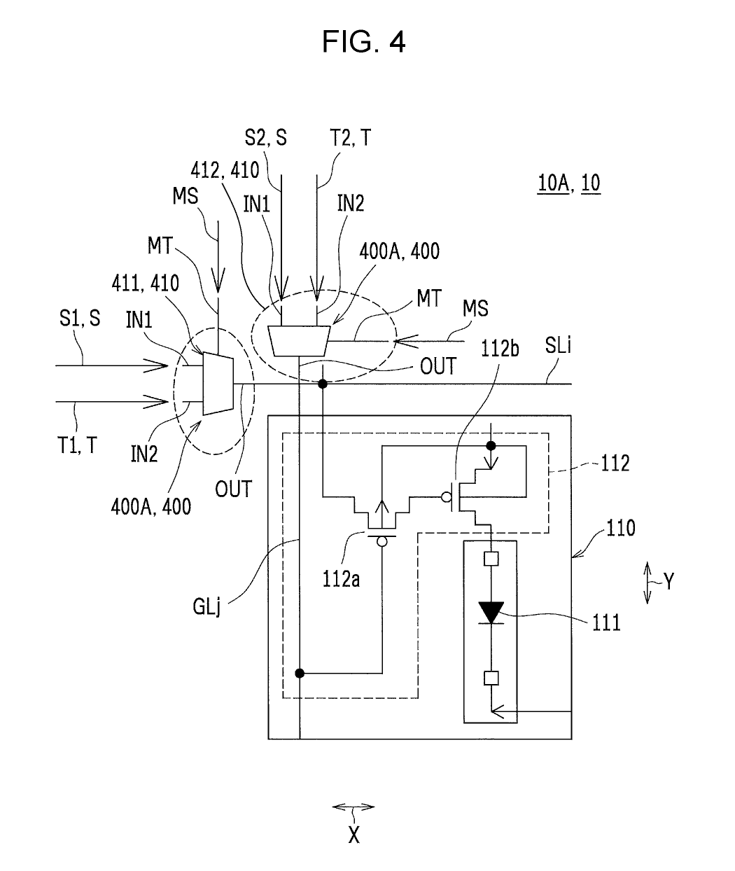

FIG. 3 is an enlarged circuit diagram of the part α1 of pixel sections 110 and test terminal sections 400A (400) of a display apparatus 10A (10) according to a first embodiment. Further, FIG. 4 is an enlarged circuit diagram of the part α2 of a pixel section 110 of the circuit diagram shown in FIG. 3.

As shown in FIGS. 3 and 4, the display apparatus 10A includes the test terminal sections 400A. The test terminal sections 400A make it possible to selectively input first image display signals S1 and a first test signal T1 (T) (see FIG. 2) to the plurality of pixel sections 110. Further, the test terminal sections 400A make it possible to selectively input second image display signals S2 and a second test signal T2 (T) (see FIG. 2) to the plurality of pixel sections 110.

Note here that the first image display signals S1 and the second image display signals S2 are signals (regular signals) that display an image on the display section 100. The first test signal T1 is a signal that is inputted from an outside source to each row of pixel sections 110 without passing through the first driver circuit section 310. The second test signal T2 is a signal that is inputted from an outside source to each column of pixel sections 110 without passing through the second driver circuit section 320.

According to the display apparatus 10A, the test signals T (T1, T2) are signals that are inputted from an outside source or test signals into which signals inputted from an outside source have been converted by dedicated circuits (e.g. level shifter circuits, DA converter circuits, or output circuits). Accordingly, the driver circuit sections 300 (310, 320) are not actuated. Further, the test terminal sections 400 (400A) selectively input the image display signals S (S1, S2) and the test signals T (T1, T2) to the plurality of pixel sections 110. This makes it possible to carry out a display check test on the plurality of pixel elements 111ii. Accordingly, the configuration can be simplified. Moreover, the test signals T (T1, T2) can be used to determine where there is a fault on the part of the drive circuits 112. Accordingly, although being simple, the configuration makes it possible to easily identify a fault part (whether there is a fault on the part of the drive circuits 112 or there is a fault on the part of the driver circuit sections 300). This is effective especially at repairing or replacing the display apparatus 10.

The test terminal sections 400A include test terminals 410 for inputting the test signals T to the plurality of pixel sections 110. In particular, as shown in FIG. 4, the test terminal sections 400A include first test terminals 411 (410) for inputting the first test signal T1 to the respective rows and second test terminals 412 (410) for inputting the second test signal T2 to the respective columns.

In this way, the test terminals 410 (411, 412) can be easily added to the driver circuit sections 300 (310, 320), respectively. This makes it possible, with a simple configuration in which the test terminals 410 (411, 412) are added in correspondence with the driver circuit sections 300 (310, 320), respectively, to determine whether there is a fault on the part of the drive circuits 112.

The test terminals 410 (411, 412) include selector circuits (in this example, multiplexer circuits).

In this way, switching between the image display signals S (S1, S2) from the driver circuit sections 300 (310, 320) and the test signals T (T1, T2) is enabled. This makes it possible, with a simple configuration, to switch between the image display signals S and the test signals T.

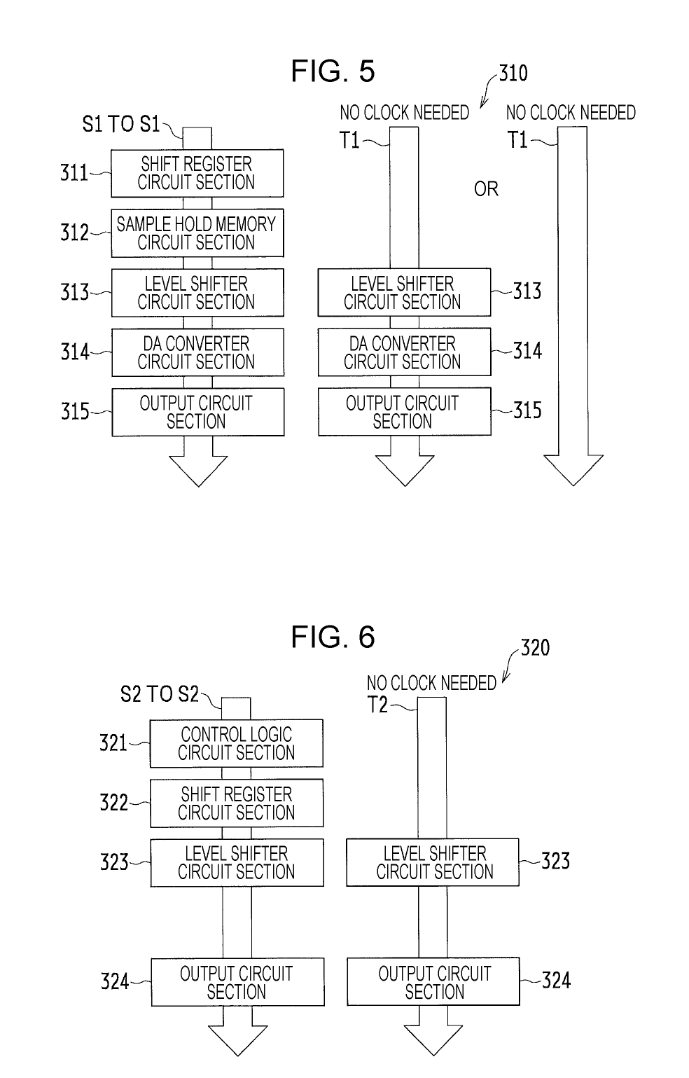

The display apparatus 10A is described in more detail. FIG. 5 is a block diagram showing the flow of signals in the first driver circuit section 310. As for the function of each block, a shift register circuit section 311 has a function of sending data represented by an inputted signal to the next register in sequence in accordance an operation clock. A sample hold memory circuit 312 has a function of holding the data of the shift register circuit section 311. A level shifter circuit section 313 has a function of converting the data of the sample hold memory circuit section 312 into a voltage at which the next circuit block (in FIG. 5, a DA converter circuit section 314) operates. The DA converter circuit section 314 has a function of converting inputted digital data into an analog value. An output circuit section 315 has a buffer function for amplifying the analog data of the DA converter circuit section 314 and transmitting a signal to each of the pixel elements 111. The present block diagram extracts only the characteristic functions of the circuit blocks of the first driver circuit section 310 and may omit other functions, and depending on the circuit configuration, it is possible to change the order or make a deletion. For example, the level shifter circuit section 313 may be deleted by making it the same in voltage of the first image display signals S1, which are input signals, as the DA converter circuit section 314.

FIG. 6 is a block diagram showing the flow of signals in the second driver circuit section 320. As for the function of each block, a control logic circuit section 321 has a function of generating an operation clock and an image signal on the basis of an inputted signal. A shift register circuit section 322 has a function of sending data represented by an inputted signal to the next register in sequence in accordance an operation clock. A level shifter circuit section 323 has a function of converting the data of the shift register circuit section 322 into a voltage at which the next circuit block (in FIG. 6, an output circuit section 324) operates. The output circuit section 324 has a buffer function for amplifying the data of the level shifter circuit section 323 and transmitting a signal to each pixel. The present block diagram extracts only the characteristic functions of the circuit blocks of the second driver circuit section 320 and may omit other functions, and depending on the circuit configuration, it is possible to change the order or make a deletion.

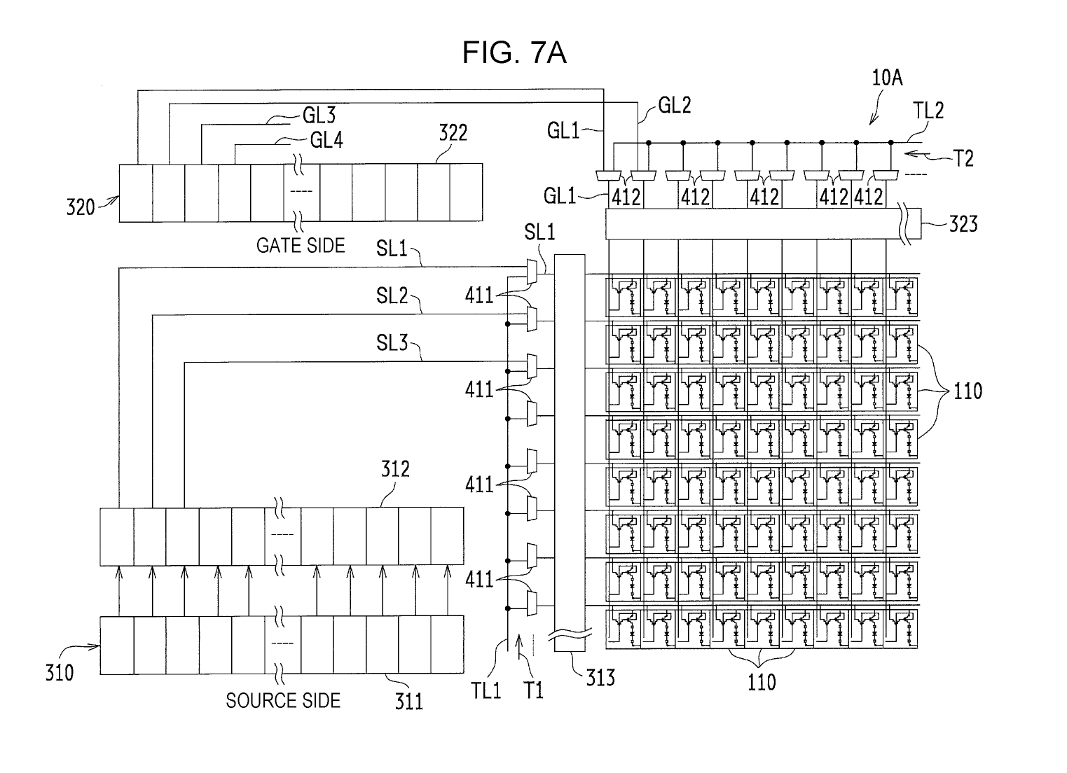

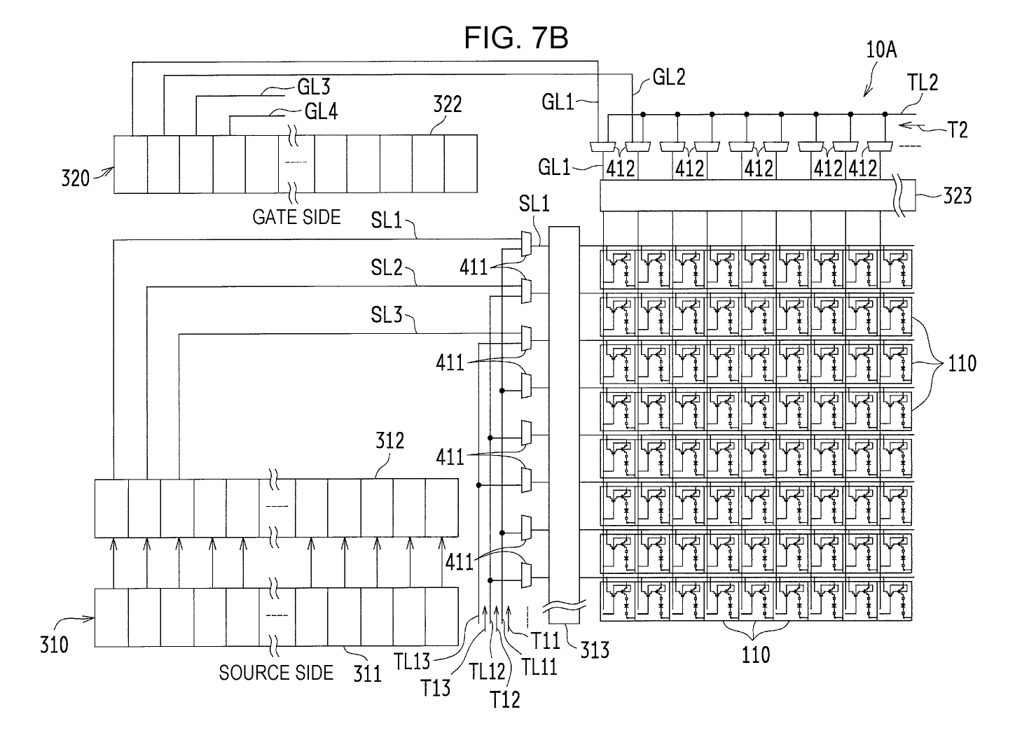

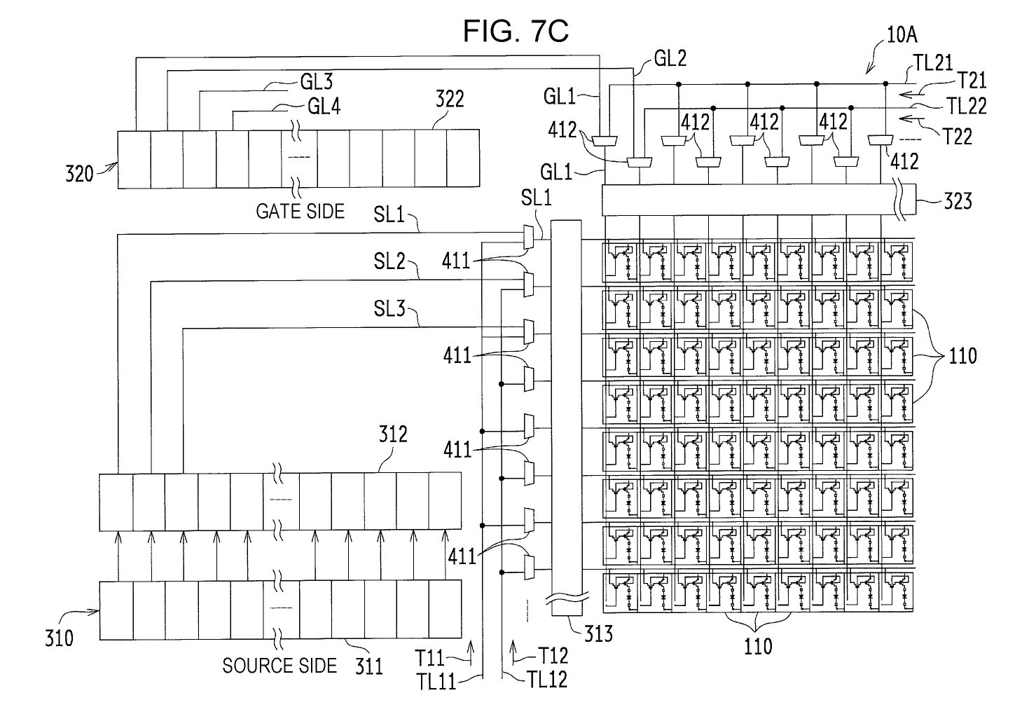

Further, FIG. 7A is a circuit diagram showing an example of a circuit configuration of the display apparatus 10A according to the first embodiment. It should be noted that FIG. 7A omits to illustrate the DA converter circuit section 314 and the output circuit sections 315 and 324. The same applies to FIGS. 7B, 7C, 8A, 9A, and 10A, which will be described later.

### Example of First Embodiment

As shown in FIG. 5, the first driver circuit section 310 includes the shift register circuit section 311, the sample hold memory circuit section 312, the level shifter circuit section 313 (voltage conversion circuit section), the DA converter circuit section 314 (digital/analog conversion circuit section), and the output circuit section 315. The first driver circuit section 310 receives various types of signal that are outputted from the control section 200 (see FIG. 1), and supplies the first image display signals S1 (data signals) to the source wires SL1 to SLm, respectively. The first image display signals S1 are inputted to the plurality of pixel sections 110 via the shift register circuit section 311, the sample hold memory circuit section 312, the level shifter circuit section 313, the DA converter circuit section 314, and the output circuit section 315. The present block configuration schematically shows functions that are needed for convenience to describe the present embodiment, and is not intended to limit the block configuration or order. Meanwhile, the first test signal T1 is inputted to the plurality of pixel sections 110 via the level shifter circuit section 313, the DA converter circuit section 314, and the output circuit section 315. Alternatively, the first test signal T1 is inputted to the plurality of pixel sections 110 without passing through the level shifter circuit section 313, the DA converter circuit section 314, or the output circuit section 315.

As shown in FIG. 6, the second driver circuit section 320 includes the control logic circuit section 321, the shift register circuit section 322, the level shifter circuit section 323 (voltage conversion circuit), and the output circuit section 324. The second driver circuit section 320 supplies the second image display signals S2 (scanning signals) to the gate wires GL1 to GLn, respectively, in accordance with various types of signal that are outputted from the control section 200. The second image display signals S2 are inputted to the plurality of pixel sections 110 via the control logic circuit section 321, the shift register circuit section 322, the level shifter circuit section 323, and the output circuit section 324. Meanwhile, the second test signal T2 is inputted to the plurality of pixel sections 110 via the level shifter circuit section 323 and the output circuit section 324.

As shown in FIG. 7A, the first test terminals 411 are provided on the m source wires SL1 to SLm, respectively. The second test terminals 412 are provided on the n gate wires GL1 to GLn, respectively.

As shown in FIG. 4, the first test terminals 411 and the second test terminals 412 each include a first input terminal IN1, a second input terminal IN2, an output terminal OUT, and a mode terminal MT. The first test terminals 411 and the second test terminals 412 each output either a signal (S) that is inputted to the input terminal IN1 or a signal (T) that is inputted to the input terminal IN2 from the output terminal OUT in accordance with a selection signal MS that is inputted to the mode terminal MT. That is, the selection signal MS is a signal for selecting either the test signal T or the image display signal S.

The test terminals 411 have their first input terminals IN1 connected to source wires SLi connected to the shift register circuit section 311 of the first driver circuit section 310, have their second input terminals IN2 connected to a single first test wire TL1 connected to a single first test terminal (not illustrated), and have their output terminals OUT connected to source wires SLi connected to the pixel sections 110.

The second test terminals 412 have their first input terminals IN1 connected to gate wires GLi connected to the shift register circuit section 322 of the second driver circuit section 320, have their second input terminals IN2 connected to a single second test wire TL2 connected to a single second test terminal (not illustrated), and have their output terminals OUT respectively connected to the gate wires GL1 to GLn connected to the pixel sections 110.

Moreover, the first test terminals 411 and the second test terminals 412 are configured such that during an image display mode, the selection signals MS of the mode terminals (MT) are turned off and the first image display signals S1 and the second image display signals S2 are outputted from the output terminals (OUT). Further, the first test terminals 411 and the second test terminals 412 are configured such that during a test mode, the selection signals MS of the mode terminals (MT) are turned on and the first test signal T1 and the second test signal T2 are outputted from the output terminals (OUT).

The display apparatus 10A thus configured can cause the plurality of pixel elements 111 to perform a total display based on the test signals T (T1, T2) and the selection signals MS. The total display not only refers to operating all pixel elements, but also can encompass selecting a part that is needed for a display check (for example, a case of causing a right and a left half to separately perform displays or dividing into multiple parts such as four parts is also possible) and causing the part to perform a display. This makes it possible to separately carry out multiple checks in a case where, due to restrictions on the capability of a test facility, a total check cannot be carried out at once. This can also contribute to reducing electrical power that is needed for a display.

In this way, a determination on whether there is a fault on the part of the drive circuits 112 can be easily made on the basis of the overall display state of the plurality of pixel elements 111.

Further, observing the light-emitting condition of each pixel makes it possible to acquire and feed back data that determines the intensity of a luminance correction signal with respect to that pixel. The correction signal can be stored in the display apparatus by providing a memory function in the apparatus, or can alternatively be stored in a memory in a display system.

### Another Example of First Embodiment

FIG. 7B is a circuit diagram showing another example of a circuit configuration of the display apparatus 10A according to the first embodiment.

In the example shown in FIG. 7B, a plurality of (three) first test signals T11, T12, and T13 (T1) are used to cause every multiple consecutive rows (every three rows) of pixel elements 111 of the plurality of pixel elements 111 to perform a display.

In this way, suitability for use in a color display apparatus is achieved. For example, color identification testing of each color can be easily carried out.

In the circuit diagram shown in FIG. 7B, the single test wire TL1 in the circuit diagram shown in FIG. 7A is replaced by the three first test wires TL11, TL12, and TL13, and three independent first test signals T11, T12, and T13 are inputted to the three first test wires TL11, TL12, and TL13, respectively. Moreover, the first first test wire TL11 is connected to the second input terminals IN2 of the first test terminals 411 in the (3×k−2)th rows. The second first test wire TL12 is connected to the second input terminals IN2 of the first test terminals 411 in the (3×k−1)th rows. Further, the third first test wire TL13 is connected to the second input terminals IN2 of the first test terminals 411 in the (3×k)th rows.

In this way, it is possible to perform a display of all (3×k−2)th rows (red rows), a display of all (3×k−1)th rows (green rows), and a display of all (3×k)th rows (blue rows) individually or in combination as a display check test on the plurality of pixel elements ill.

Further, it is also possible to carry out a total display test in which all of the pixel elements 111 are caused to perform a display.

In such a configuration or the configuration shown in FIG. 7A, a plurality of the second test signals T2 may be used to cause every multiple consecutive columns (e.g. every three columns) of pixel elements 111 of the plurality of pixel elements 111 to perform a display.

For example, in the circuit diagram shown in FIG. 7B, the single second test wire TL2 in the circuit diagram shown in FIG. 7A is replaced by three second test wires, and three independent second test signals are inputted to the three second test wires, respectively. Moreover, assuming that h is an integer of 1 or greater, a first one of the second test wires is connected to the second input terminals IN2 of the second test terminals 412 in the (3×h−2)th columns. A second one of the second test wires is connected to the second input terminals IN2 of the second test terminals 412 in the (3×h−1)th columns. Further, a third one of the second test wires is connected to the second input terminals IN2 of the second test terminals 412 in the (3×h)th columns.

In this way, it is possible to perform a display of all (3×h−2)th columns, a display of all (3×h−1)th columns, and a display of all (3×h)th columns individually or in combination as a display check test on the plurality of pixel elements 111.

Further, it is also possible to carry out a total display test in which all of the pixel elements 111 are caused to perform a display.

A test on every multiple consecutive rows may be achieved without an increase in the number of test signals T by using a plurality of test signals T and a plurality of selection signals MS to be inputted to the test terminals 410 and, at the same time, inputting different selection signals MS for each separate terminal to be checked.

The order of red, green, and blue is an example of a case where a display apparatus is made white, and any order of red, green, and blue will do. Further, it is also possible to add yellow (Y), cyan (C), and magenta (M). In that case, it is only necessary to add as many test wires as the colors, and it is also possible to reduce the number of test signals by testing a plurality of colors at the same time. Further, as for a display apparatus that is not intended for use in full color, it is possible to use any single color or any combination of colors, making it possible to provide a similar function by preparing test wires for each separate color as mentioned above. Further, in a case where a plurality of luminescent colors are present on an identical source wire SLi or gate wire GLi as in the case of a Bayer arrangement, a similar display test is enabled by combining the first test wires TL11, TL12, and TL 13 and second test wires TL21, TL22, and TL23.

The present function is not only effective at testing but also makes it possible to drive the plurality of pixel elements 111 at the same time, and can therefore be used for a high-speed shutdown from a normal image display and the resetting of a display image.

### Still Another Example of First Embodiment

FIG. 7C is a circuit diagram showing still another example of a circuit configuration of the display apparatus 10A according to the first embodiment.

In the example shown in FIG. 7C, a plurality of (two) first test signals T11 and T12 (T1) are used to cause every multiple consecutive rows (every two rows) of pixel elements 111 of the plurality of pixel elements 111 to perform a display, and a plurality of (two) second test signals T21 and T22 (T2) are used to cause every multiple consecutive columns (every two columns) of pixel elements 111 of the plurality of pixel elements 111 to perform a display.

In this way, suitability for use in a color display apparatus is achieved. For example, color identification testing of each color can be easily carried out.

In the circuit diagram shown in FIG. 7C, the single first test wire TL1 in the circuit diagram shown in FIG. 7A is replaced by two first test wires TL11 and TL12, and two independent first test signals T11 and T12 are inputted to the two first test wires TL11 and TL12, respectively. Moreover, the first first test wire TL11 is connected to the second input terminals IN2 of the first test terminals 411 in the (2×k−1)th rows. Further, the second first test wire TL12 is connected to the second input terminals IN2 of the first test terminals 411 in the (2×k)th rows.

In this way, it is possible to perform a display of all (2×k−1)th rows (red rows) and all (2×k)th rows (blue rows) and a display of all (2×k+1)th rows (green rows) and all (2×k+2)th rows (red rows) individually as a display check test on the plurality of pixel elements 111.

Furthermore, the single second test wire TL2 is replaced by two second test wires TL21 and TL22, and two independent second test signals T21 and T22 are inputted to the two second test wires TL21 and TL22, respectively. Moreover, the first second test wire TL21 is connected to the second input terminals IN2 of the second test terminals 412 in the (2×h−1)th columns. Further, the second second test wire TL22 is connected to the second input terminals IN2 of the second test terminals 412 in the (2×h)th columns.

In this way, it is possible to perform a display of all (2×h−1)th columns and all (2×h)th columns and a display of all (2×h+1)th columns and all (2×h+2)th columns individually.

Further, it is also possible to carry out a total display test in which all of the pixel elements 111 are caused to perform a display.

It should be noted that at least two of the examples shown in FIGS. 7A, 7B, and 7C may be combined.

Further, in the first embodiment, four or more first test signals T1 may be used to cause every four or more consecutive rows of pixel elements 111 of the plurality of pixel elements 111 to perform a display, and four or more second test signals T2 may be used to cause every four or more consecutive columns of pixel elements 111 of the plurality of pixel elements 111 to perform a display.

By being installed in space to connect the driver circuit sections 300 (310, 320) and the drive circuits 112, the test terminal sections 400 (400A) enable a test on the pixel sections 110 regardless of the state of the driver circuits. Alternatively, the test terminal sections 400 (400A) may also be installed in parts in the driver circuits where circuit blocks are connected. In this case, diverting some of the circuits in the drivers makes it possible to reduce the number of dedicated circuits for test signals, making it possible to achieve a reduction in chip area. For example, in the case of the first driver circuit section 310, providing the test terminal sections 400 (400A) between the DA converter circuit section 314 and the output circuit section 315, which are shown in FIG. 5, enables the output circuit section 315 to generate voltages that are needed to drive each separate pixel element 111, eliminating the need for dedicated circuits. In such a case, since the voltages that are needed to drive the pixel elements 111 are generated inside, it is no longer necessary to apply a high voltage from an outside source for use in testing. This makes it possible, for example, to reduce wire widths, making it possible to achieve a reduction in chip area.

Not only are selection signals MS dedicatedly inputted from an outside source, but also test signals T may be used as selection signals MS. Alternatively, it is possible to use test signals T generated from test signals T or other signals.

### Second Embodiment

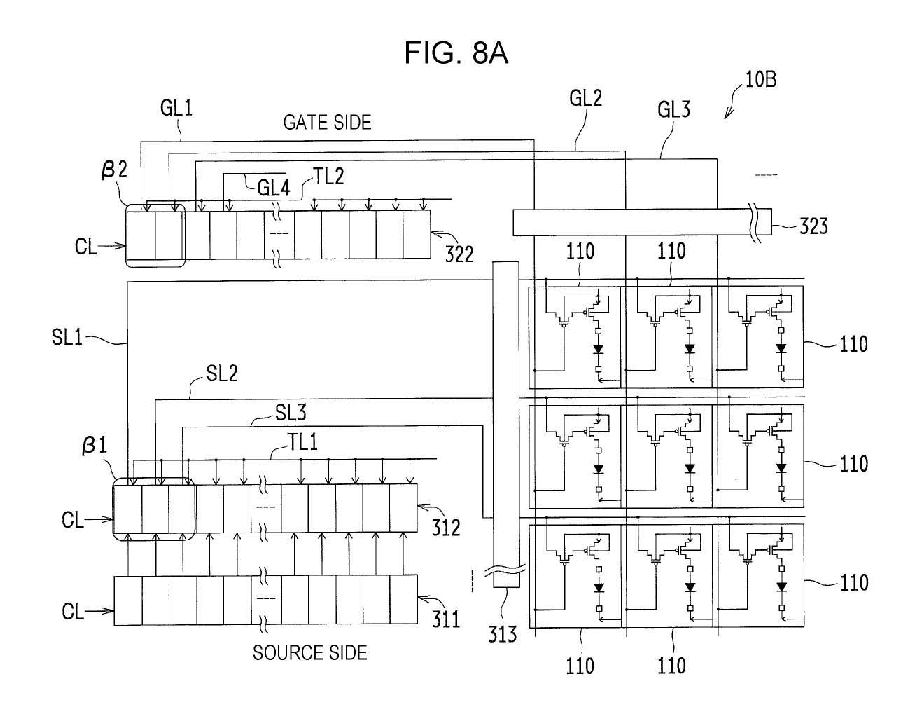

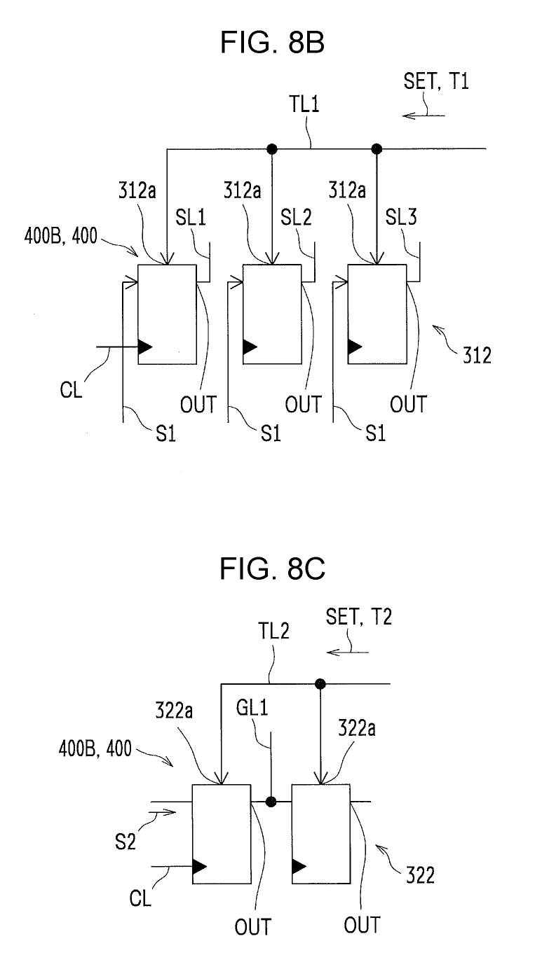

FIG. 8A is a circuit diagram showing an example of a circuit configuration of a display apparatus 10B (10) according to a second embodiment. FIG. 8B is an enlarged circuit diagram of a part pi of a gate-side sample hold memory circuit section 312 of the display apparatus 10B shown in FIG. 8A. FIG. 8C is an enlarged circuit diagram of a part P2 of a gate-side shift register circuit section 322 of the display apparatus shown in FIG. 8A.

As shown in FIGS. 8A to 8C, a test terminal section 400B (400) may be configured by diverting some of the driver circuits or adding a function.

In this way, a display check is enabled without separately providing the test terminal section 400B.

The test terminal section 400 can contain a set function, and the test signals T (T1, T2) or the selection signals MS, which are switching signals, are used as set signals for the set function.

In this way, the test terminal sections can be configured with a simple configuration in which the set function is contained. Note here the set function is a function that is made the same by inputting set signals SET as the function provided by turning on the test signals T (T1, T2) in the first embodiment. The set signals are signals for enabling (turning on) outputs, and signals that are needed to drive the pixel elements 111 connected to the drive circuits 112 can be outputted.

The test terminal section 400B is an example of addition of the set function to the sample hold memory circuit section 312 and the gate-side shift register circuit section 322, needs only be configured such that test signals are outputted in accordance with signals in a manner similar to the set function, and is not intended to limit a circuit function.

The display apparatus 10B according to the second embodiment makes it possible to perform the same operation as that of the first embodiment by modifying the existing circuits, or circuits may be newly added.

### Example of Second Embodiment

A source-side shift register circuit section 311 performs a shift operation (clock operation) in accordance with a clock signal CL and thereby selects data for the first image display signals S1 to be outputted to the source wires SL1 to SLm connected thereto. A sample hold memory circuit section 312 samples and stores the data selected by the shift register circuit section 311. Further, the sample hold memory circuit section 312 is further provided with the set function, and when a set signal SET (first test signal T1 or selection signal MS) is inputted to the sample hold memory circuit section 312, the pixel elements 111 connected to the sample hold memory circuit section 312 are driven. A gate-side shift register circuit section 322 performs a shift operation (clock operation) in accordance with a clock signal CL and thereby selects data for the second image display signals S2 to be outputted to the gate wires GL1 to GLn connected thereto. Further, the gate-side shift register circuit section 322 is further provided with the set function, and when a set signal SET (second test signal T2 or selection signal MS) is inputted to the gate-side shift register circuit section 322, the pixel elements 111 connected to the gate-side shift register circuit section 322 are driven.

In the display apparatus 10B thus configured, during normal times (reset times) of the sample hold memory section 312 and the gate-side shift register circuit section 322, the sample hold memory section 312 and the gate-side shift register circuit section 322 have their set signals in an OFF-state. Meanwhile, at the time of inputting of the set signals SET (T1 or MS) and SET (T2 or MS), ON-signals are outputted to the output of the first driver circuit section 310 and the output of the second driver circuit section 320. In this way, the display apparatus 10B is brought into the same state as the state in the first embodiment (see FIG. 4) where the ONs of the first and second test signals T1 and T2 are inputted to the second input terminals IN2 of the first and second test terminals 411 and 412.

As shown in FIG. 8B, the sample hold memory circuit section 312 has its first set terminals 312a connected to a single first test wire TL1 connected to a single first test terminal (not illustrated), and has its output terminals OUT respectively connected to the source wires SL1 to SLm connected to the pixel sections 110.

As shown in FIG. 8C, the gate-side shift register circuit section 322 has its second set terminals 322a connected to a single test wire TL2 connected to a single second test terminal (not illustrated), and has its output terminals OUT respectively connected to the gate wires GL1 to GLn connected to the pixel sections 110.

This allows the sample hold memory circuit section 312 and the gate-side shift register circuit section 322 to output the first image display signals S1 and the second image display signals S2 from the output terminals OUT as an image display mode during normal times (reset times). Meanwhile, at the time of inputting of the set signals SET (T1) and SET (T2), the sample hold memory circuit section 312 and the gate-side shift register circuit section 322 can output, from the output terminals OUT, the first test signal T1 and the second test signal T2 or outputs that are needed to cause the pixels to perform a display.

The display apparatus 10B thus configured can cause the plurality of pixel elements 111 to perform a total display based on the test signals T (T1, T2) or the selection signals MS.

In this way, a determination on whether there is a fault on the part of the drive circuits 112 can be easily made on the basis of the overall display state of the plurality of pixel elements 111.

It should be noted that the test terminal section 400B may be one obtained by adding the set function to the shift register circuit section 311 instead of the sample hold memory circuit section 312.

Thus, a function which is similar to that of the first embodiment can be provided by using some blocks of the driver circuits, and this function may be provided separately from the driver circuits.

### Another Example of Second Embodiment

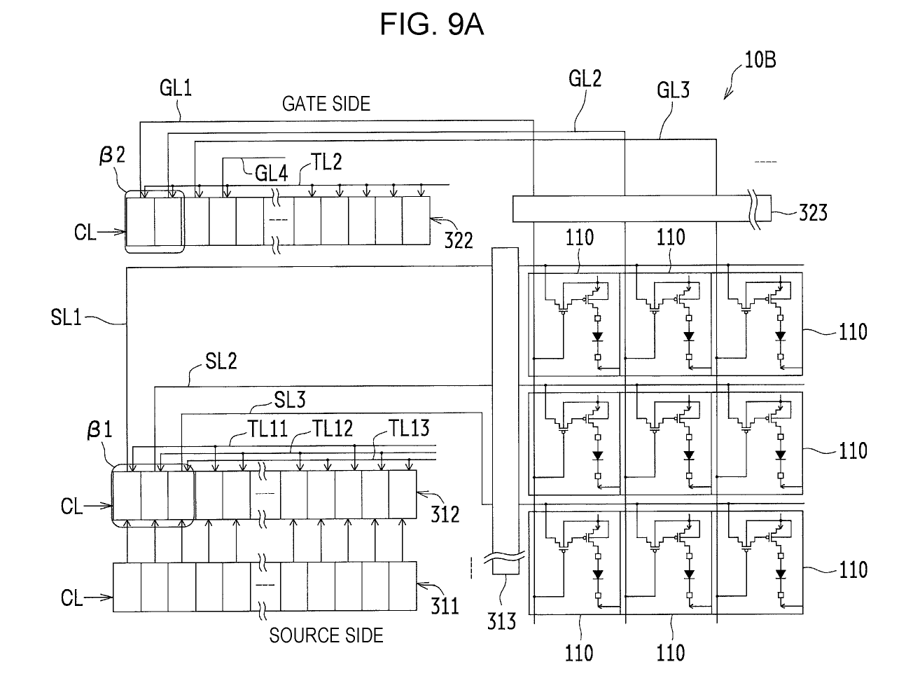

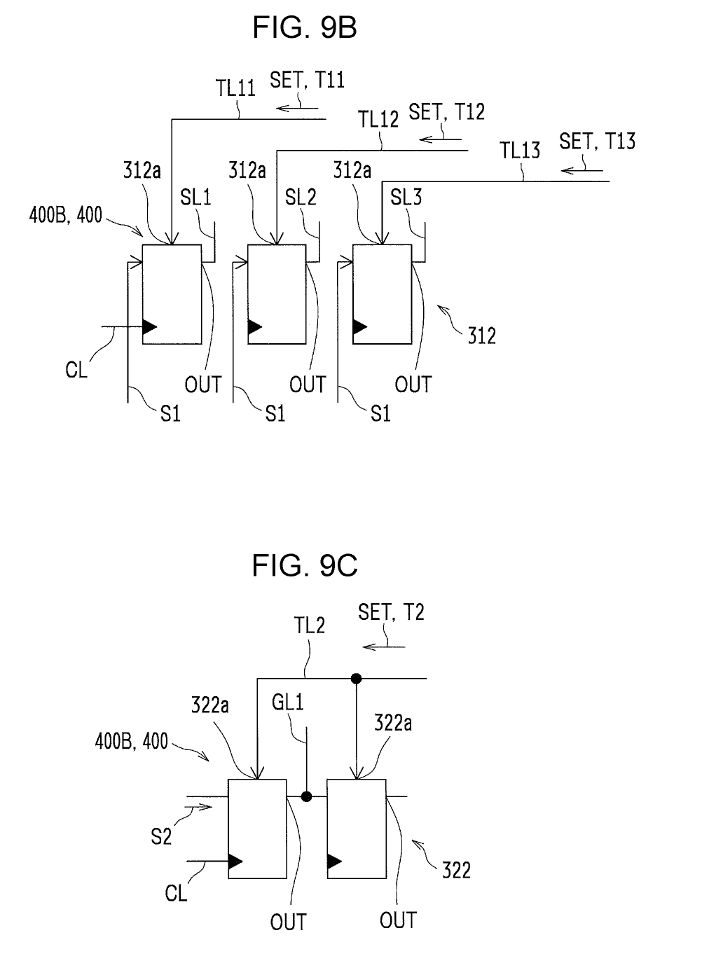

FIG. 9A is a circuit diagram showing another example of a circuit configuration of the display apparatus 10B according to the second embodiment. FIG. 9B is an enlarged circuit diagram of a part pi of a gate-side sample hold memory circuit section 312 of the display apparatus 10B shown in FIG. 9A. FIG. 9C is an enlarged circuit diagram of a part (2 of a gate-side shift register circuit section 322 of the display apparatus 10B shown in FIG. 9A.

In the examples shown in FIGS. 9A to 9C, a plurality of (three) first test signals T11, T12, and T13 are used to cause every multiple consecutive rows (every three rows) of pixel elements 111 of the plurality of pixel elements 111 to perform a display. In this way, an effect which is similar to that of the example shown in FIG. 7B can be brought about.

In the circuit diagrams shown in FIGS. 9A to 9C, the single test wire TL in the circuit diagrams shown in FIGS. 8A to 8C is replaced by three first test wires TL11, TL12, and TL13, and three independent first test signals T11, T12, and T13 are inputted to the three first test wires TL11, TL12, and TL13, respectively. Moreover, in the sample hold memory circuit section 312, as shown in FIG. 9B, the first first test wire TL11 is connected to the first set terminals 312a in the (3×k−2)th rows. The second first test wire TL12 is connected to the first set terminals 312a in the (3×k−1)th rows. Further, the third first test wire TL13 is connected to the first set terminals 312a in the (3×k)th rows.

In such a configuration or the configuration shown in FIG. 8A, a plurality of second test signals T2 may be used to cause every multiple consecutive columns (e.g. every three columns) of pixel elements 111 of the plurality of pixel elements 111 to perform a display.

For example, in the circuit diagrams shown in FIGS. 9A to 9C, the single second test wire TL2 in the circuit diagrams shown in FIGS. 8A to 8C is replaced by three second test wires, and three independent second test signals are inputted to the three second test wires, respectively. Moreover, in the gate-side shift register circuit section 322, a first one of the second test wires is connected to the second set terminals 322a in the (3×h−2)th columns. A second one of the second test wires is connected to the second set terminals 322a in the (3×h−1)th columns. Further, a third one of the second test wires is connected to the second set terminals 322a in the (3×h)th columns.

In this way, it is possible to perform a display of all (3×h−2)th columns, a display of all (3×h−1)th columns, and a display of all (3×h)th columns individually or in combination as a display check test on the plurality of pixel elements 111.

Further, it is also possible to carry out a total display test in which all of the pixel elements 111 are caused to perform a display.

Although the present example has illustrated a case where test signals T (T11, T12, T13, T21, T22, T23) are used to switch every multiple columns, a similar function is also enabled by using a plurality of selection signals MS.

### Still Another Example of Second Embodiment

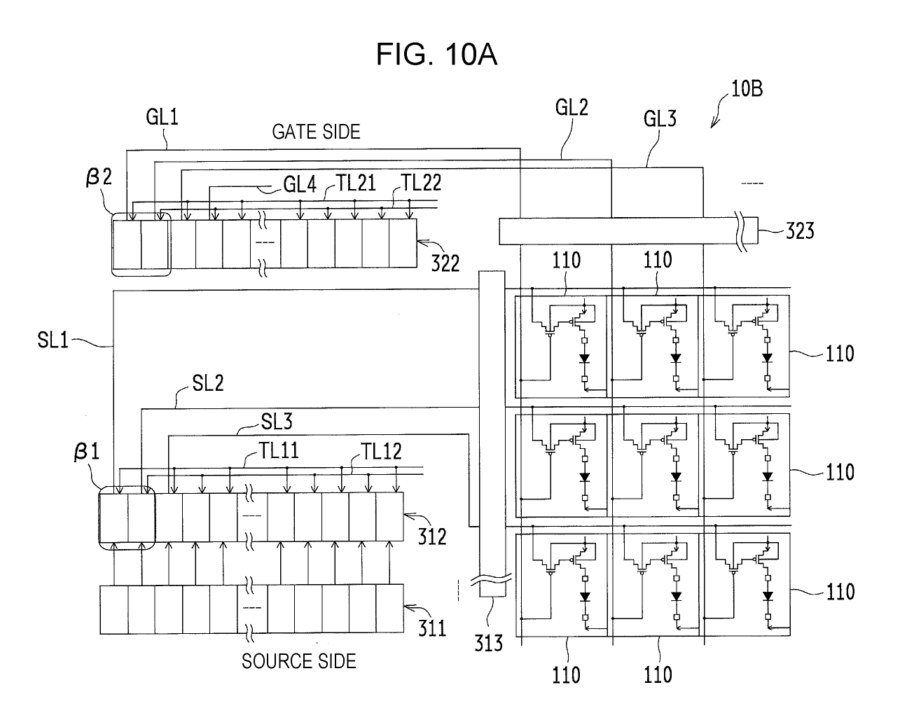

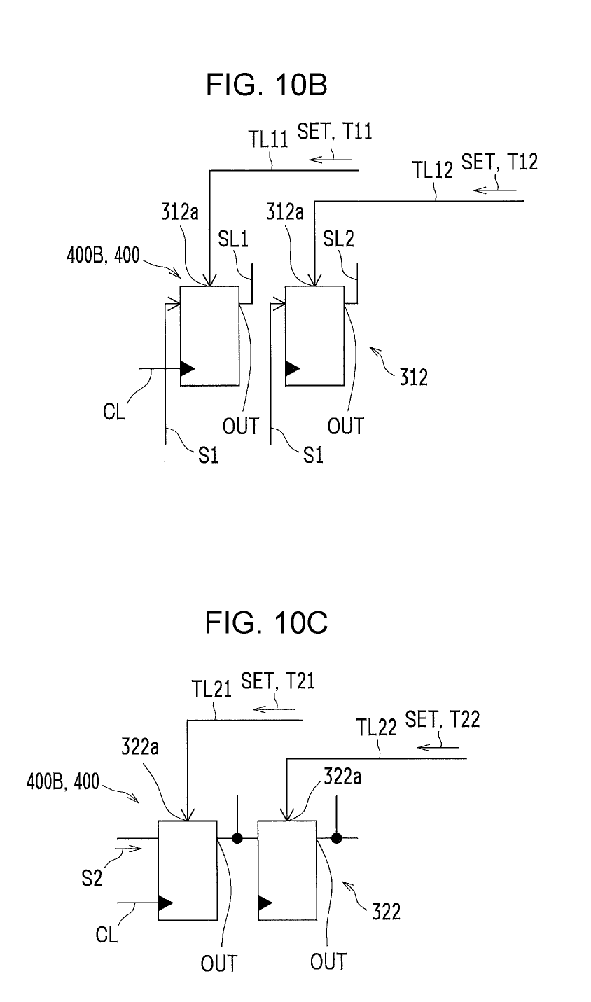

FIG. 10A is a circuit diagram showing still another example of a circuit configuration of the display apparatus 10B according to the second embodiment. FIG. 10B is an enlarged circuit diagram of a part pi of a gate-side sample hold memory circuit section 312 of the display apparatus 10B shown in FIG. 10A. FIG. 10C is an enlarged circuit diagram of a part P2 of a gate-side shift register circuit section 322 of the display apparatus 10B shown in FIG. 10A.

In the examples shown in FIGS. 10A to 10C, a plurality of (two) first test signals T11 and T12 (T1) are used to cause every multiple consecutive rows (every two rows) of pixel elements 111 of the plurality of pixel elements 111 to perform a display, and a plurality of (two) second test signals T21 and T22 (T2) are used to cause every multiple consecutive columns (every two columns) of pixel elements 111 of the plurality of pixel elements 111 to perform a display. In this way, an effect which is similar to that of the example shown in FIG. 7C can be brought about.

In the circuit diagrams shown in FIGS. 10A to 10C, the single first test wire TL1 in the circuit diagrams shown in FIGS. 8A to 8C is replaced by two first test wires TL11 and TL12, and two independent first test signals T11 and T12 are inputted to the two first test wires TL11 and TL12, respectively. Moreover, in the sample hold memory circuit section 312, as shown in FIG. 10B, the first first test wire TL11 is connected to the first set terminals 312a in the (2×k−1)th rows. Further, the second first test wire TL12 is connected to the first set terminals 312a in the (2×k)th rows.

Furthermore, the single second test wire TL2 is replaced by two second test wires TL21 and TL22, and two independent second test signals T21 and T22 are inputted to the two second test wires TL21 and TL22, respectively. Moreover, in the gate-side shift register circuit section 322, as shown in FIG. 10C, the first second test wire TL21 is connected to the second set terminals 322a in the (2×h−1) th columns. Further, the second second test wire TL22 is connected to the second set terminals 322a in the (2×h) th columns.

It should be noted that at least two of the examples shown in FIGS. 8A, 9A, and 10A may be combined.

Further, in the second embodiment, four or more first test signals T1 may be used to cause every four or more consecutive rows of pixel elements 111 of the plurality of pixel elements 111 to perform a display, and four or more second test signals T2 may be used to cause every four or more consecutive columns of pixel elements 111 of the plurality of pixel elements 111 to perform a display.

Further, the test terminal section 400B may be one obtained by adding the set function to the source-side shift register circuit section 311.

### Third Embodiment

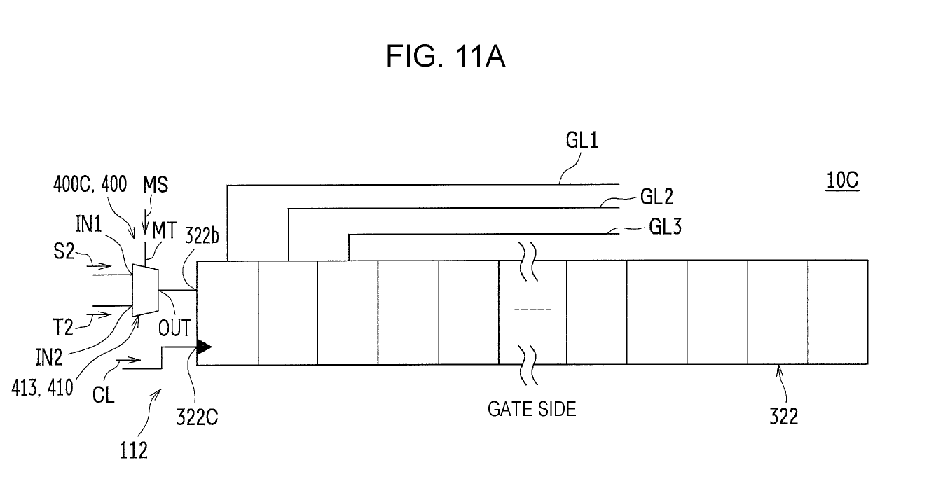

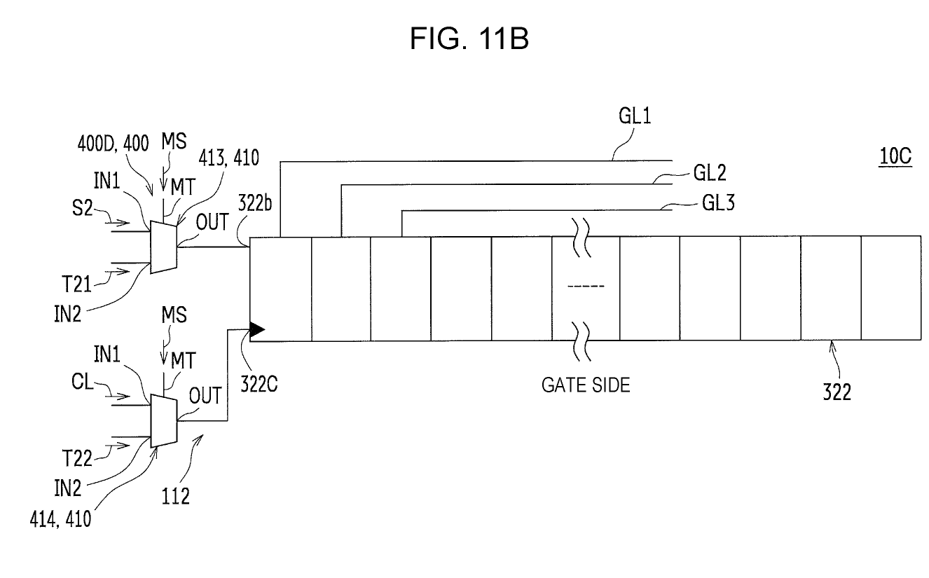

FIG. 11A is a circuit diagram schematically showing a configuration of the part of a gate-side shift register circuit section 322 in an example of a display apparatus 10C (10) according to a third embodiment. Further, FIG. 11B is a circuit diagram schematically showing a configuration of the part of a gate-side shift register circuit section 322 in another example of a display apparatus 10C (10) according to the third embodiment.

As shown in FIGS. 11A and 11B, a test terminal section 400C (400) is provided on an upstream side of drive circuits 112 that drive a plurality of pixel elements 111.

In this way, a determination on whether there is a fault on the part of the drive circuits 112 can be easily made with a simple configuration in which the test terminal section 400C is added to the upstream side of the drive circuits 112. Further, for example, when the plurality of pixel elements 111 operate normally in accordance with the second test signal T2, it can be confirmed that a downstream side of the drive circuits 112 is normal and there is a fault on the upstream side of the drive circuits 112.

The drive circuits 112 include a shift register circuit section 322. The test terminal section 400C is connected to the shift register circuit section 322.

In this way, a display check test on the plurality of pixel elements 111 can be conducted using the shift register circuit section 322 and the second test signal T2. This allows the shift register circuit section 322 to surely input the second test signal T2 to the plurality of pixel sections 110.

### Example of Third Embodiment

As shown in FIG. 11A, the test terminal section 400C is connected to the gate-side shift register circuit section 322. The test terminal section 400C includes a third test terminal 413 (410). The third test terminal 413 is a selector circuit (in this example, a multiplexer circuit).

In this way, switching between the second image display signal S2 and the second test signal T2 is enabled. This makes it possible, with a simple configuration, to switch between the second image display signal S2 and the test signal T2.

In the example shown in FIG. 11A, the second test signal T2 is used to cause every multiple consecutive columns (e.g. every two columns) of pixel elements 111 of the plurality of pixel elements 111 to perform a display. In this way, an effect which is similar to that of the examples shown in FIGS. 7C and 10A can be brought about.

The third test terminal 413 is similar in configuration to the first test terminals 411 and the second test terminals 412. The third test terminal 413 has a first input terminal IN1 to which the second image display signal S2 is inputted, a second input terminal IN2 to which the second test signal T2 is inputted, and an output terminal OUT connected to an enable terminal 322b of the gate-side shift register circuit section 322. A clock signal CL is inputted to a clock terminal 322c of the gate-side shift register circuit section 322.

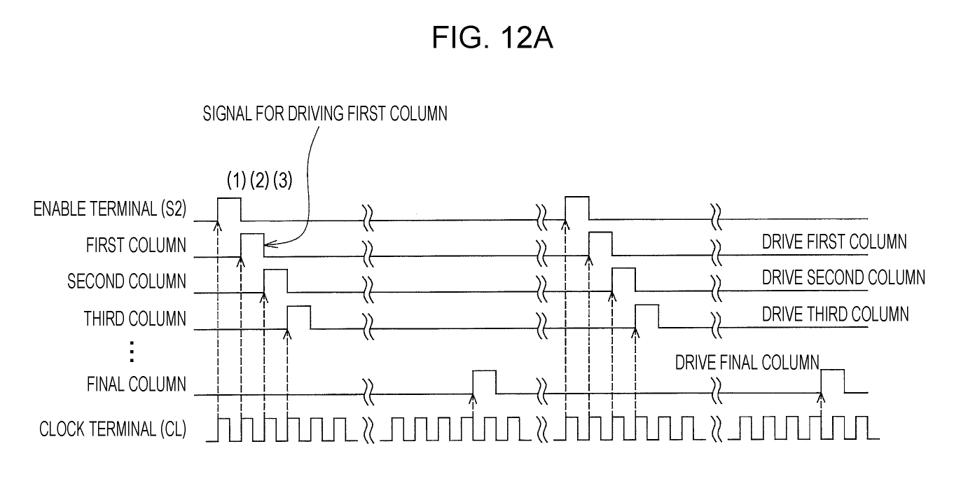

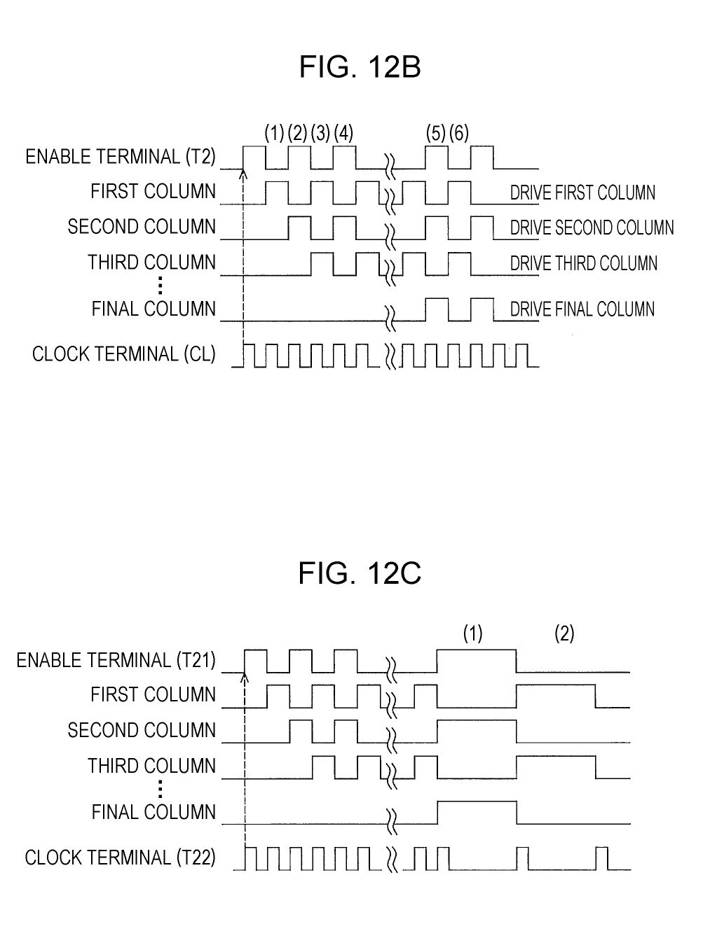

In the example shown in FIG. 11A, for example, the following operation can be performed. FIG. 12A is an example of a timing chart of the gate side shift register circuit section 322 during normal operation. FIG. 12B is an example of a timing chart of the gate-side shift register circuit section 322 shown in FIG. 11A during test operation.

During normal operation in the example shown in FIG. 12A, the selection signal MS of the mode terminal MT is turned off to bring about an image display mode in which the second image display signal S2 is inputted again to the enable terminal 322b of the shift register circuit section 322 after the driving of the final column, whereby sequential inputting takes place. This subjects multiple columns of pixel elements 111 to drive operation. That is, the second image display signal S2 drives (1) a first column of pixel elements 111, (2) a second column of pixel elements 111, (3) a third column of pixel elements 111, and so on. Meanwhile, during test operation in the example shown in FIG. 12B, the selection signal MS of the mode terminal MT is turned on to bring about a test mode in which the second test signal T2 that is inputted to the enable terminal 322b of the shift register circuit section 322 drives (1) the first column of pixel elements 111, (2) the second column of pixel elements 111, (3) the first and third columns of pixel elements 111, and (4) the first and third columns of pixel elements 111, drives (5) the second column of pixel elements 111, . . . , and the final column of pixel elements (even-numbered column driving), and drives (6) the first column of pixel elements 111, the third column of pixel elements 111, and so on (odd-numbered column driving). By proceeding with such sequential inputting, alternate driving (or driving of a given part) is performed.

### Another Example of Third Embodiment

The display apparatus 10C of the example shown in FIG. 11B is one obtained by making the display apparatus 10C of the example shown in FIG. 11A include a fourth test terminal 414 (410).

As shown in FIG. 11B, a test terminal section 400D (400) is connected to the gate-side shift register circuit section 322. The test terminal section 400D includes a third test terminal 413 and a fourth test terminal 414. The fourth test terminal 414 is a selector circuit (in this example, a multiplexer circuit).

In this way, switching between the second image display signal S2 and the second test signal T21 is enabled, and switching between the clock signal CL and the second test signal T22 is enabled. This makes it possible, with a simple configuration, to switch between the second image display signal S2 and the test signal T21 and between the clock signal CL and the second test signal T22.

In the example shown in FIG. 11B, the second test signals T21 and T22 are used to cause every multiple consecutive columns (e.g. every two columns) of pixel elements 111 of the plurality of pixel elements 111 to perform a display. In this way, an effect which is similar to that of the examples shown in FIGS. 7C and 10A can be brought about.

In the third test terminal 413, the second test terminal T21 is inputted to the second input terminal IN2 of the third test terminal 413. The fourth test terminal 414 is similar in configuration to the first test terminals 411 and the second test terminals 412.

The fourth test terminal 414 has a first input terminal IN1 to which the clock signal CL is inputted, a second input terminal IN2 to which the second test signal T22 is inputted, and an output terminal OUT connected to the clock terminal 322c of the gate-side shift register circuit section 322.

In the example shown in FIG. 11B, for example, the following operation can be performed. FIG. 12C is an example of a timing chart of the gate-side shift register circuit section 322 shown in FIG. 11B during test operation.

The test operation of the example shown in FIG. 12C is the same in basic operation as the test operation of the example shown in FIG. 12B, and makes it possible to control drive time by adding clock control. The second test signal T21 that is inputted to the enable terminal 322b of the shift register circuit section 322 drives (1) the second, fourth, . . . , and final columns (even-numbered columns) of pixel elements 111 until the next rising edge of the second test signal T22 that is inputted to the clock terminal 322c of the shift register circuit section 322, and drives (2) the first, third, and . . . (odd-numbered columns) of pixel elements 111 until the next rising edge of the second test signal T22. Although this example has illustrated even-numbered columns and odd-numbered columns, it is possible to arbitrarily set columns of driving depending on the input state of the second test signals T21 and T22.

In the third embodiment, the second test signal T2 may be used to cause three or more consecutive columns of pixel elements 111 to perform a display.

### Fourth Embodiment

A display apparatus 10 according to a fourth embodiment is one obtained by configuring the display apparatus 10 of any one of the first to third embodiment to commonalize a selection signal MS and a normal signal G that is inputted during normal operation to a plurality of pixel sections 110.

In this way, the normal signal G and the selection signal MS can share a common terminal with each other.

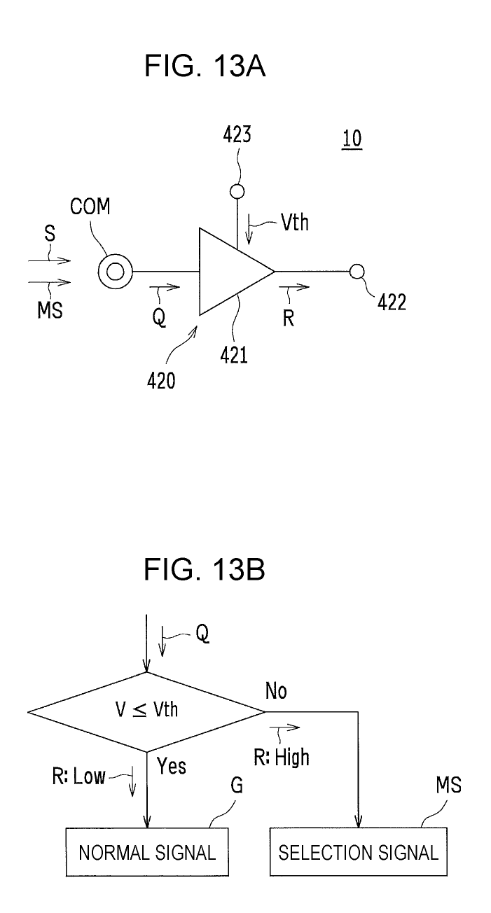

FIG. 13A shows an example of an operation circuit of a discrimination section 420 that discriminates between a normal signal G and a selection signal MS.

As shown in FIG. 13A, the display apparatus 10 includes the discrimination section 420 that discriminates between a normal signal G and a selection signal MS. The discrimination section 420 has a common terminal COM and an output terminal 422.

In this way, a determination on whether an input signal Q that is inputted to the common terminal COM is a normal signal G (e.g. an image display signal S (S1, S2)) or a selection signal MS can be easily made in accordance with an output signal R that is outputted from the output terminal 422 of the discrimination section 420.

In a test terminal 410 of the first embodiment, in a case where a first image display signal S1 and a selection signal MS are inputted to the common terminal COM of the discrimination section 420, the output terminal 422 of the discrimination section 420 is connected to the source wire SLi and the mode terminal MT. Further, in a test terminal 410 of the first or third embodiment, in a case where a second image display signal S2 and a selection signal MS are inputted to the common terminal COM of the discrimination section 420, the output terminal 422 of the discrimination section 420 is connected to the gate wire GLj and the mode terminal MT.

A selection signal MS contains discrimination information for discriminating it from a normal signal G.

In this way, a determination on whether the input signal Q that is inputted to the common terminal COM is a normal signal G or a selection signal MS can be achieved with a simple configuration.

In particular, the discrimination section 420 shown in FIG. 13A further includes a detection circuit 421 (in this example, a comparison circuit) that detects discrimination information (in this example, a voltage) such as a voltage or command added to the selection signal MS. The detection circuit 421 includes a reference terminal 423. A reference voltage Vth is applied to the reference terminal 423.

FIG. 13B is an example of an operation chart of the discrimination section 420 that discriminates between a normal signal G and a selection signal MS.

As shown in FIG. 13B, the discrimination section 420 discriminates, according to whether a voltage V of the input signal Q inputted to the common terminal COM is not higher than the reference voltage Vth (e.g. 4 V), whether the input signal Q is a normal signal G or a selection signal MS. In this example, when the voltage V of the input signal Q inputted to the common terminal COM is not higher than the reference voltage Vth, the discrimination section 420 selects a normal signal G, as the output signal R is “Low”. When the voltage V of the input signal Q inputted to the common terminal COM exceeds the reference voltage Vth, the discrimination section 420 selects the selection signal MS, as the output signal R is “High”.

It should be noted that a selection signal MS containing discrimination information can be generated within a circuit section that generates a normal signal G or a circuit section (e.g. a driver circuit section 300 (310, 320)) through which a normal signal G passes, or may alternatively be inputted from an outside source.

### Fifth Embodiment

A normal signal G may not only be commonalized with a selection signal MS of a test signal T and an image display signal S, but may also be commonalized with other signals. For example, a selection signal MS and a correction signal such as a luminance correction signal for the display section 100 (image display section) may be commonalized.

### Sixth Embodiment

In a sixth embodiment, the pixel elements 111 used may be liquid crystal elements instead of being light-emitting elements.

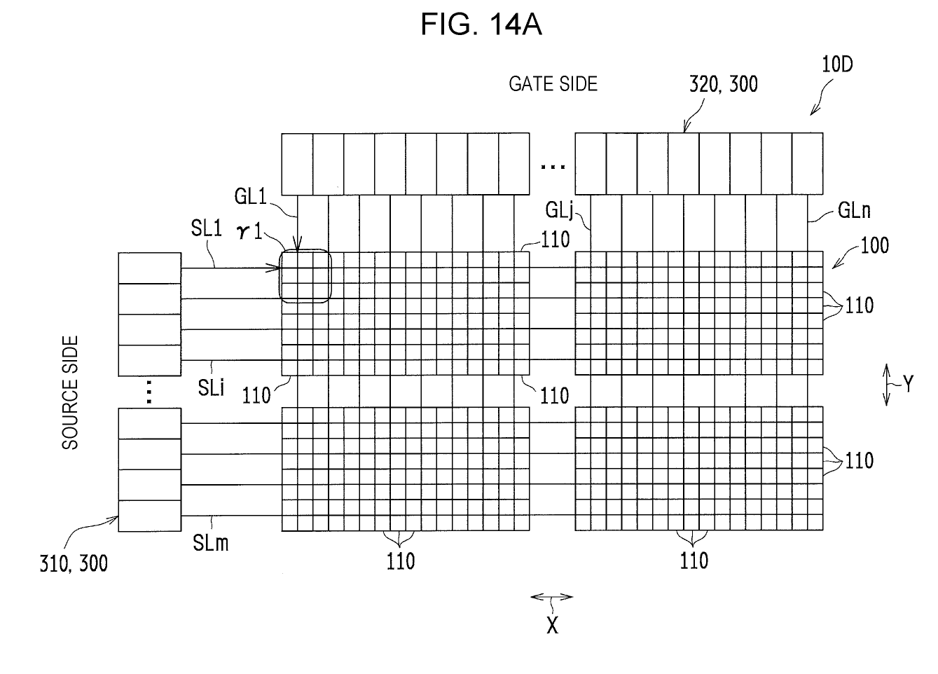

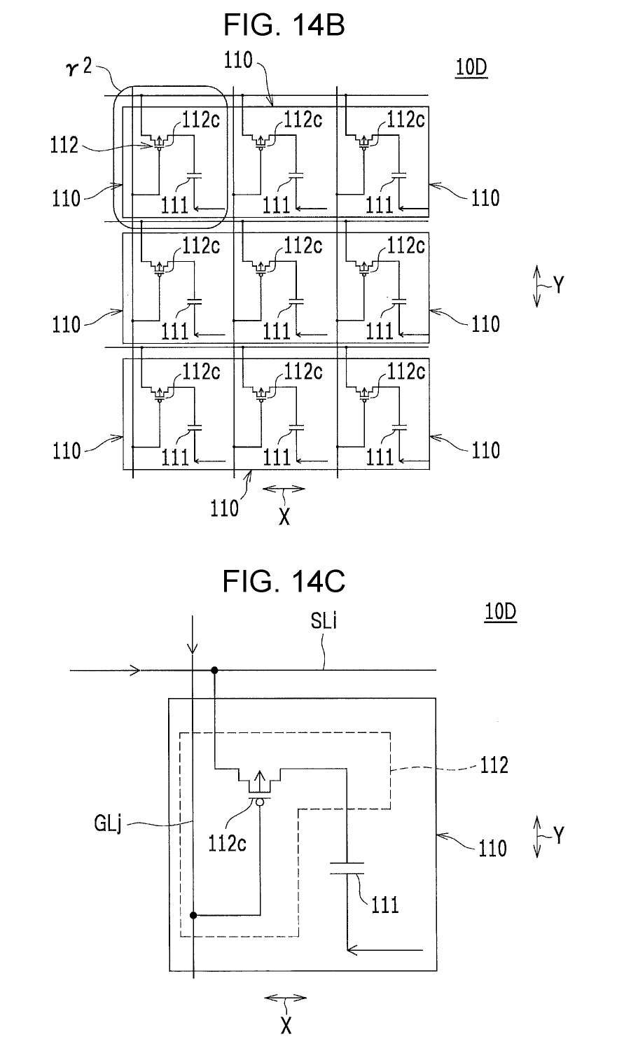

FIG. 14A is a circuit diagram schematically showing a circuit configuration of a display apparatus 10D (10) including liquid crystal elements. FIG. 14B is an enlarged circuit diagram of the part γ1 of pixel sections 110 of the display apparatus 10D including liquid crystal elements. Further, FIG. 14C is an enlarged circuit diagram of the part γ2 of a pixel section 110 of the circuit diagram shown in FIG. 14B.

In the example shown in FIG. 14A, the first driver circuit section 310 includes a source driver circuit, and the second driver circuit section 320 includes a gate driver circuit. As shown in FIGS. 14A and 14B, each of the pixel sections 110 includes a drive element 112c (TFT: thin-film transistor) and a pixel element 111. The drive element 112c is connected to the gate wire GLj, and has its source terminal connected to the source wire SLi. Further, the drive element 112c has its drain terminal connected to the pixel element 111. In the display apparatus 10D, the drive circuits 112 and the pixel elements 111 are integrally formed.

The present disclosure is also applicable to such a liquid crystal display apparatus 10D as that shown in FIG. 14A.

### Seventh Embodiment

It is conceivable here that a display check test may be carried out with the driver circuit sections 300 (310, 320) unconnected. For example, although, in the second embodiment, the test terminal section 400B partially shares the sample hold memory circuit section 312 and the shift register circuit section 322, a liquid crystal display apparatus may be a display apparatus from which the driver circuit sections 300 have been removed.

### Eighth Embodiment

A display check test on the plurality of pixel elements 111 is effective especially for a display apparatus in which the driver circuit section(s) 300 (both or either 310 and/or 320) and the drive circuits 112 are formed on a single chip or a display apparatus 10E (10) in which the driver circuit section(s) 300 (both or either 310 and/or 320) and the drive circuits 112 are integrally formed in a later step.

### Example of Method for Manufacturing Display Apparatus 10E

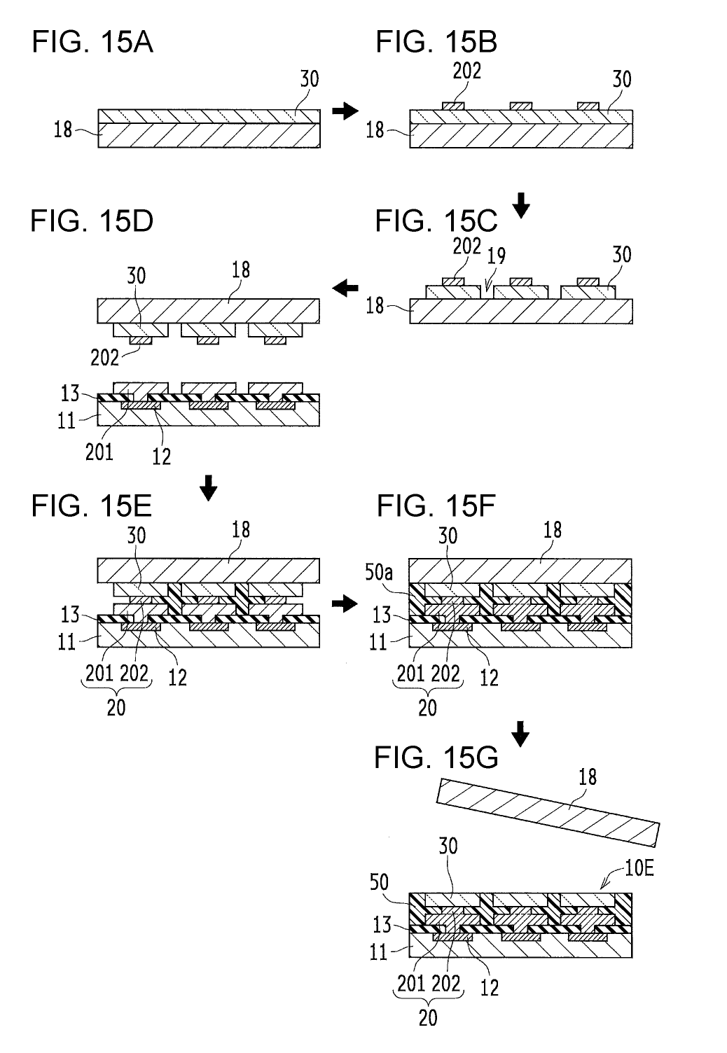

Next, in regard to a display apparatus and a display check test method in which the driver circuit section(s) 300 (both or either 310 and/or 320) and the drive circuits 112 are formed on a single chip or mounted in a later step and the pixel elements 111 are bonded in a later step, an example of a method for manufacturing a target display apparatus 10E is described below with reference to FIGS. 15A to 15G. It should be noted that a display check test on the plurality of pixel elements 111 may be applied to a display apparatus in which the driver circuit section(s) 300 (both or either 310 and/or 320), the drive circuits 112, and the plurality of pixel elements 111 are integrally formed on an identical substrate or a display apparatus in which the driver circuit section(s) 300 (both or either 310 and/or 320), the drive circuits 112, and the plurality of pixel elements 111 are mounted on their respective substrates and integrally formed in a later step.

FIGS. 15A to 15G are explanatory diagrams for explaining manufacturing steps of an example of a method for manufacturing a display apparatus 10E. Prior to a description of the method for manufacturing the display apparatus 10E, an electrode 20 and a metal wire 12 are described.

The electrode 20 is an electrode made, for example, of gold (Au) or Au—Sn (whose surface is made of Au), and serves to electrically connect a substrate 11 to a pixel element (in this example, a blue light-emitting element 30). Specifically, the electrode 20 functions as a pad electrode that electrically connects the metal wire 12 to a metal terminal (not illustrated) provided on a surface of the blue light-emitting element 30, and is also called “bump”. Since the blue light-emitting element 30 is connected to the electrode 20 in a later step, it is desirable that the electrode 20 have a flat or gently-curved surface, and it is desirable that the electrode 20 not be damaged or rugged due to contact with a test probe or the like.

The metal wire 12 is a wire that includes at least a control circuit that supplies a control voltage to the blue light-emitting element 30. A first portion of the electrode 20 that is connected to the metal wire 12 is a substrate-side electrode 201, and a second portion of the electrode 20 that is connected to the metal terminal (not illustrated) provided on the surface of the blue light-emitting element 30 is a light-emitting-element-side electrode 202.

### Step of Forming Blue Light-Emitting Element 30

First, as shown in FIG. 15A, the blue light-emitting element 30 is provided on a growth substrate 18. The growth substrate 18 is a substrate that epitaxially grows a semiconductor layer of the blue light-emitting element 30. As substrates in the III-V compound semiconductors and the III nitride semiconductors, publicly-known ones can be used. Further, as the III-V compound semiconductors and the III nitride semiconductors, publicly-known ones can be used.

### Step of Forming Light-Emitting-Element-Side Electrodes 202

After the formation of the blue light-emitting element 30, as shown in FIG. 15B, a plurality of the light-emitting-element-side electrodes 202 are formed on the blue light-emitting element 30. This formation involves the use of a well-known common electrode formation technique. A representative example of a material of the light-emitting-element-side electrodes 202 is gold (Au).

### Step of Forming Isolation Trenches 19

After the formation of the light-emitting-element-side electrodes 202, as shown in FIG. 15C, a plurality of isolation trenches 19 are formed in the blue light-emitting element 30. This formation involves the use of a standard semiconductor selective etching process. In FIG. 15C, an isolation trench 19 is formed between adjacent light-emitting-element-side electrodes 202. The isolation trenches 19 thus formed reach a surface of the growth substrate 18. The formation of the isolation trenches 19 divides the single blue light-emitting element 30 into a plurality of individual blue light-emitting elements 30 on the surface of the growth substrate 18.

### Step of Aligning Two Substrates

After the formation of the isolation trenches 19, as shown in FIG. 15D, a substrate 11 having drive circuits with metal wires 12, an insulation layer 13, and substrate-side electrodes 201 formed in advance is prepared. The insulation layer 13 is an insulating layer composed of an oxide layer, a resin film, and a resin layer. The insulation layer 13 prevents direct contact between the substrate 11 and electrodes 20. The formation of the substrate-side electrodes 201 with respect to the substrate 11 involves the use of a well-known common electrode formation technique. A representative example of a material of the substrate-side electrodes 201 is gold (Au). In parallel with the preparation of the substrate 11, as shown in FIG. 15D, the growth substrate 18 is inverted. After the inversion, the substrate 11 and the growth substrate 18 are aligned so that each of the substrate-side electrodes 201 and the corresponding one of the light-emitting-element-side electrodes 202 face each other.

### Step of Bonding Substrate 11

After completion of the alignment, as shown in FIG. 15E, the substrate 11 and the growth substrate 18 are bonded together. In so doing, an existing bonding technique is used to hold the substrate 11 and the growth substrate 18 under upward and downward pressures so that each of the substrate-side electrodes 201 and the corresponding one of the light-emitting-element-side electrodes 202 are joined to each other. In addition, the reactivity between each of the substrate-side electrodes 201 and the corresponding one of the light-emitting-element-side electrodes 202 may be enhanced by a process of heating the substrate 11 during the step of bonding the substrate 11, and clean surfaces of the electrodes 20 may be exposed by a plasma process that precedes the bonding of the substrate 11. The process of heating the substrate 11 and the plasma process make it possible to more firmly join each of the substrate-side electrodes 201 and the corresponding one of the light-emitting-element-side electrodes 202 to each other. Thus, each of the substrate-side electrodes 201 and the corresponding one of the light-emitting-element-side electrodes 202 are combined with each other to form an electrode 20.

### First Display Check Test Step

After the step of bonding the substrate 11 and before the next step of forming a resin 50, a display check test on the pixel elements 111 (check test in which all pixels are lit) is carried out for determining whether there is a failure/no failure in that state. In a case where it is determined that there is no failure, the process proceeds to the next step, and in a case where it is determined that there is a failure, the tested item is found to be a defective item and is reworked (modified) or eliminated.

### Step of Forming Resin 50

After completion of the bonding step, vacant spaces formed between the substrate 11 and the growth substrate 18 are filled with a liquid resin 50a. The filled state is shown in FIG. 15F. In so doing, for example, immersion in a container filled with the liquid resin 50a needs only take place in the bonded state. Examples of a chief material of the liquid resin 50a include, but are not particularly limited to, epoxy resin. The method for injecting the liquid resin 50a may be replaced by a method for injecting the liquid resin 50a with an injection needle, or particularly, a microneedle fitted to the size of vacant spaces formed between the substrate 11 and the blue light-emitting elements 30. In this case, the injection needle is made of metal, plastic, or the like.

In the filling step, it is preferable that filling of the liquid resin 50a take place at a temperature falling within a temperature range of 50° C. to 200° C. This makes it easy to normally fill the vacant spaces with the liquid resin 50a. Furthermore, it is more preferable that the temperature range be 80° C. to 170° C. This makes it possible to reduce the risk of impairing the properties (such as adhesion and radiation performance after a curing process) of the resin 50. Further, it is still more preferable that the temperature range be 100° C. to 150° C. This allows less bubbles or the like to be generated in the vacant spaces and allows almost perfect filling without the occurrence of convection, making it easy to manufacture the display apparatus 10E.

Assume, in particular, a case where the size of each individual blue light-emitting element 30 is such a minute size that, for example, the length and breadth are 20 μm or smaller, more preferably several micrometers to several tens of micrometers, and the thickness of the blue light-emitting element 30 is approximately 10 μm (2 μm to 15 μm). In this case, the liquid resin 50a more usefully functions as a reinforcing member for improving fixing strength in substrate delamination and a step that follows the delamination. This makes it possible to reduce variations in the properties of the resin 50 among products, thus making it easy to manufacture the display apparatus 10E. The products are products in which, in a top view, the size of each individual blue light-emitting element 30 is such that the length and breadth are 20 μm or smaller, more preferably several micrometers to several tens of micrometers.

As shown in FIG. 15F, the liquid resin 50a filling the vacant spaces is completely buried in the vacant spaces. This causes the liquid resin 50a to be buried on the side surfaces of the blue light-emitting elements 30, on the side and stepped surfaces of the electrodes 20, and on top of the substrate 11. After completion of the filling of the liquid resin 50a, the liquid resin 50a is cured. Examples of a method for curing the liquid resin 50a include, but are not particularly limited to, curing the liquid resin 50a by heating the liquid resin 50a or by irradiating the liquid resin 50 with ultraviolet rays.

### Second Display Check Test Step

After the step of forming the resin 50 and before the next step of delaminating the growth substrate 18, a display check test on the pixel elements 111 (check test in which all pixels are lit) is carried out for determining whether there is a failure/no failure in that state. In a case where it is determined that there is no failure, the process proceeds to the next step, and in a case where it is determined that there is a failure, the tested item is found to be a defective item and is reworked (modified) or eliminated.

### Step of Delaminating Growth Substrate 18

After completion of the filling step, as shown in FIG. 15G, the growth substrate 18 is delaminated. This step involves the use of an existing delaminating technique. As an example of existing delaminating means, a delamination technique that involves the use of irradiation with laser light can be used. For example, in a case where a transparent substrate of sapphire or the like is used as a growth substrate for the blue light-emitting elements 30 and a III nitride semiconductor is crystal-grown as a light-emitting layer, it is possible to reduce damage to a crystal-growth layer by irradiation with laser light from the side of the transparent substrate under given conditions. It is also possible to delaminate the growth substrate 18 using a wet-etching method, grinding, a polishing method, or the like as another means.

Since the resin 50 tightly fixes the electrodes 20 and the blue light-emitting elements 30 to the substrate 11, the electrodes 20 and the blue light-emitting elements 30 can be prevented from being delaminated together with the growth substrate 18 when the growth substrate 18 is delaminated. After the delamination of the growth substrate 18, light exit surfaces of the blue light-emitting elements 30 and an upper surface of the resin 50 are exposed. Further, after the delamination of the growth substrate 18, the light exit surfaces of the blue light-emitting elements 30 and the upper surface of the resin 50 are substantially flush with each other.

Irradiation with laser light only exerts an influence on parts of several nanometer to several tens of nanometer of the blue light-emitting elements 30 that face the growth substrate 18, and the influence is sufficiently small.

Further, after the delamination of the growth substrate 18, the smoothness of a surface including the light exit surfaces of the blue light-emitting elements 30 after the delamination can be improved by use of CMP (chemical mechanical polishing) and/or wet etching. Further, a post-delamination residue can be removed. The improvement in smoothness and the removal of the post-delamination residue make it easier to form a color conversion layer 40 in the next step, making it possible to improve the efficiency of light extraction of light that is emitted from the blue light-emitting elements 30.

In a case where the blue light-emitting elements 30 used are made of a GaN material or an InGaN material, the delamination of the growth substrate 18 in the present delaminating step forms light exit surfaces made of the GaN material. In general, the light exit surfaces of the blue light-emitting elements 30 after the delamination of the growth substrate 18 are composed of Ga and N. However, depending on conditions of manufacture of the blue light-emitting elements 30 and conditions of delamination, there can be a case where the light exit surfaces of the blue light-emitting elements 30 are composed solely of Ga and a case where the light exit surfaces of the blue light-emitting elements 30 are composed solely of Ga. The eighth embodiment assumes that the light exit surfaces of the blue light-emitting elements 30 are made of a GaN material, including both a case where the light exit surfaces are composed solely of Ga and a case where the light exit surfaces are composed solely of N.

### Third Display Check Test Step

After the step of delaminating the growth substrate 18 and before the next step of forming the color conversion layer 40, a display check test on the pixel elements 111 (check test in which all pixels are lit) is carried out for determining whether there is a failure/no failure in that state. In a case where it is determined that there is no failure, the process proceeds to the next step, and in a case where it is determined that there is a failure, the tested item is found to be a defective item and is reworked (modified) or eliminated.

### Step of Forming Color Conversion Layer 40

After completion of the delaminating step, the color conversion layer 40 can be formed by one of the following steps (1) to (3). The following steps (1) to (3) are examples of a step of forming the color conversion layer 40.

(1) A fluorescence substance is kneaded with a photosensitive curable resin (photoresist), and the resulting product is applied to the light exit surfaces of the blue light-emitting elements 30 and the upper surface of the resin 50. A fluorescence pattern is formed by using a common photolithography step to leave a resist containing a necessary phosphor.

(2) A lift-off photoresist pattern is formed by using a common photo process in a position where no fluorescence pattern is left. After a phosphor-containing resin has been applied onto this photoresist pattern, a phosphor-containing resin pattern (color conversion layer 40) is formed by lifting off the photoresist pattern. The phosphor-containing resin may be applied with a spray.

(3) A phosphor-containing ink is directly formed by using a common printing technique. At this point in time, the ink may contain a pigment as well as the phosphor.

### Fourth Display Check Test Step

After the step of forming the color conversion layer 40 and before the next step of forming a fixing resin 60, a display check test on the pixel elements 111 (check test on emission of each color of light) is carried out for determining whether there is a failure/no failure in that state. In a case where it is determined that there is no failure, the process proceeds to the next step, and in a case where it is determined that there is a failure, the tested item is found to be a defective item and is reworked (modified) or eliminated. Further, checking the intensity of each luminescent color enables use in the creation of data that corrects the intensity of a signal that is generated from image data.

### Step of Forming Fixing Resin 60

A color conversion layer 40 (plate-shaped color conversion layer) having a surface identical in area to the light exit surfaces of the blue light-emitting elements 30 is prepared, and the color conversion layer 40 is placed on the blue light-emitting elements 30. The color conversion layer 40 is fixed to the blue light-emitting elements 30 and the resin 50 by covering the side and upper surfaces of the color conversion layer 40 and the upper surface of the resin 50 with resin (liquid resin yet to be solidified to form the fixing resin 60). After completion of the step of forming the fixing resin 60, the manufacture of the display apparatus 10E is completed. The step of forming the fixing resin 60 described here is an example.

As noted above, in the manufacture of the display apparatus 10E, the growth substrate 18 (sapphire substrate) is delaminated; therefore, the display apparatus 10E thus manufactured can be thinner than a display apparatus including a growth substrate 18 by the thickness (normally approximately 100 μm) of the growth substrate 18. This brings the color conversion layer 40 into direct contact with the light exit surfaces of the blue light-emitting elements 30 in the display apparatus 10E. That is, all surfaces of contact of the color conversion layer 40 with the blue light-emitting elements 30 make direct contact with the light exit surfaces of the blue light-emitting elements 30.

Since there is no growth substrate 18 between the color conversion layer 40 and the blue light-emitting elements 30, direct contact between the color conversion layer 40 and the blue light-emitting elements 30 shortens a pathway of dissipation of heat generated by the color conversion layer 40, making it possible to improve radiation performance. Since the scattering of light by the growth substrate 18 can be reduced, the efficiency of light extraction and the uniformity of light emission can be improved. This makes it possible to emit high-luminance light from the color conversion layer 40. Further, the removal of the growth substrate 18 reduces the overall size of the display apparatus 10E.

The aforementioned manufacturing method is merely an example of a method that makes it possible to manufacture the display apparatus 10E. The steps described here are intended to make it easy to manufacture the display apparatus 10E, and steps that constitute the method for manufacturing the display apparatus 10E are not limited to these steps.

Further, the blue light-emitting elements 30 are examples of light-emitting elements, and a plurality of light-emitting elements with different luminescent colors may be combined regardless of coloring. For example, use of ultraviolet light with a wavelength of 410 nm or lower makes a white display possible with a change and/or addition of a phosphor. Further, it is also possible to combine red (R), green (G), and blue (B).

### OTHER EMBODIMENTS

Possible examples of pixel elements include light-emitting elements, liquid crystal elements, and the like. Possible examples of light-emitting elements include light-emitting diode elements, semiconductor laser elements, organic light-emitting diodes (OLEDs), and spin light-emitting diode elements. The plurality of pixel elements 111 according to the embodiments described above may be constituted by red light-emitting elements, green light-emitting elements, and blue light-emitting elements as well as the blue light-emitting elements 30 according to the embodiments described above, and furthermore, a combination of light-emitting diode elements with different luminescent colors is possible. Further, it is also possible to perform a color conversion using a phosphor. Especially in the case of a white display, color reproducibility can be enhanced by using light-emitting elements with different luminescent colors of red (R), green (G), and blue (B). In this case, the present technique is effective, as the light-emitting elements are connected in a later step. Further, possible examples of liquid crystal elements include liquid crystal panel elements.

Further, both or either the drive circuit section(s) 310 and/or 320 and the drive circuits 112 may be of a single-chip structure. In particular, in such a manufacturing method as that shown in the seventh embodiment in which pixel elements are joined in a later step onto a chip in which the driver circuit sections 300 (310, 320) and the drive circuits 112 are of a single-chip structure, there are terminals that connect drive circuits for pixels with the pixel elements. In a preceding step in which the pixel elements are yet to be joined, the terminals of drive circuit sections are in an open state, and in the case of a test in an LSI state, a test probe needs to be prepared for the terminal of each drive circuit section. In the case of an m×n matrix, it is difficult to test all circuits, as m×n or more probe are needed. Further, in order for the pixel elements to be joined to connection terminals, it is desirable that the connection terminals have flat or gently-curved surfaces during joining, and since it is desirable that no contact with probes be made during testing, it is desirable that no test be carried out on the drive circuits. For example, checking of operation of the driver circuits can be performed by probing external image signal input terminals, power sources, control terminals, and driver circuit output sections (at least either or both SLi or/and GLi) by providing test PADs. Meanwhile, such a method is conceivable that the drive circuit sections are not probed and checking of operation thereof is not performed. The method for checking operation is an example and is not intended to impose any limitation, and such a method is possible that checking of operation is performed with probes applied to some of the drive circuits. Therefore, no test is conducted on some circuits on the LSI circuit, and since the pixel elements are joined in a later step, which of the driver circuit sections 300 (310, 320), the drive circuits 112, and the pixel elements is malfunctioning can be grasped in the case of an original fault in a drive circuit or a fault attributed to damage of the chip during joining, a contact failure at a junction, or the like.

Further, also in the case of a direct or TAB (tape automated bonding) connection between the driver circuit sections 300 (310, 320) and the drive circuits 112, which are of a single-chip structure, which of the driver circuit sections 300 (310, 320) and the drive circuits 112 is malfunctioning can be grasped, including post-connection damage.

Further, the pixel elements 111 that constitute the pixel sections 110 and the drive circuits that drive the pixel elements 111 may be formed in a stack structure (laminate structure).

Further, examples of systems in which a display apparatus according to an aspect of the present disclosure can be suitably used include, but are not particularly limited to, a liquid crystal display system, a VR (virtual reality) system, an AR (augmented reality) system, an MR (mixed reality) system, a laser projection system, an LED projection system, and similar systems.

According to the present embodiment, a display apparatus may include: a plurality of pixel sections including a plurality of pixel elements, respectively; drive circuits that input image display signals to the plurality of pixel sections and drive the pixel elements, respectively; driver circuits; a substrate on which the plurality of pixel sections, the drive circuits, and the driver circuits are formed; and test terminals via which the image display signals and test signals that are inputted from an outside source are selectively inputted to the plurality of pixel sections. In the display apparatus, the pixel elements that constitute the pixel sections and the drive circuits that drive the pixel elements may be formed in a stack structure.

According to the present embodiment, a display apparatus may include: a plurality of pixel sections including a plurality of pixel elements, respectively; driver circuit sections that input image display signals to the plurality of pixel sections; drive circuits that drive the pixel elements, respectively; driver circuits; a substrate on which the drive circuits and the driver circuits are formed; and test terminals via which the image display signals and test signals that are inputted from an outside source are selectively inputted to the plurality of pixel sections. In the display apparatus, the pixel elements that constitute the pixel sections and the drive circuits that drive the pixel elements may be formed in a stack structure.

According to the present embodiment, a display apparatus may include: a plurality of pixel sections including a plurality of pixel elements, respectively; driver circuit sections that input image display signals to the plurality of pixel sections; drive circuits that drive the pixel elements, respectively; driver circuits; and a substrate on which the drive circuits and the driver circuits are formed. In the display apparatus, the pixel elements that constitute the pixel sections and the drive circuits that drive the pixel elements may be formed in a stack structure, and the driver circuits may generate test signals in accordance with test signals that are inputted from an outside source, and may input the test signals thus generated to the plurality of pixel sections.

According to the present embodiment, a display check test method for carrying out a display check test on a plurality of pixel elements of a display apparatus including a plurality of pixel sections, including the plurality of pixel elements, respectively, to which image display signals are inputted may include selectively inputting, to the plurality of pixel sections, the image display signals and test signals that are inputted from an outside source.

According to the present embodiment, a display check test method for carrying out a display check test on a plurality of pixel elements of a display apparatus including a plurality of pixel sections including the plurality of pixel elements, respectively, and driver circuit sections that input image display signals to the plurality of pixel sections may include selectively inputting, to the plurality of pixel sections, the image display signals and test signals that are inputted from an outside source.

According to the present embodiment, in a display check test method for carrying out a display check test on a plurality of pixel elements of a display apparatus including a plurality of pixel sections including the plurality of pixel elements, respectively, and driver circuit sections that input image display signals to the plurality of pixel sections, the driver circuit sections may generate test signals in accordance with test signals that are inputted from an outside source, and may input the test signals thus generated to the plurality of pixel sections.

In the display check test method according to the present embodiment, the display check test may be carried out on a display apparatus in which the driver circuit sections and drive circuits that drive the plurality of pixel elements are formed on a single chip or a display apparatus in which the driver circuit sections and drive circuits that drive the plurality of pixel elements are integrally formed in a later step.

The present disclosure is not limited to the embodiments described above but may be carried out in other various forms. Therefore, the embodiments are mere examples in all respects and should not be interpreted in a limited way. The scope of the present disclosure is indicated by the scope of the claims and is not bound in any way by the body of the specification. Furthermore, all modifications and alternations belonging to the equivalents of the scope of the claims are encompassed in the scope of the present disclosure.

The present disclosure contains subject matter related to that disclosed in Japanese Priority Patent Application JP 2018-020313 filed in the Japan Patent Office on Feb. 7, 2018, the entire contents of which are hereby incorporated by reference.

1. A display apparatus comprising:
a plurality of pixel sections, each having a pixel element, to which image display signals are inputted; and
test terminals via which the image display signals and test signals that are inputted from an outside source are selectively inputted to the plurality of pixel sections.

2. A display apparatus comprising:
a plurality of pixel sections each having a pixel element;
driver circuit sections that input image display signals to the plurality of pixel sections; and
test terminals via which the image display signals and test signals that are inputted from an outside source are selectively inputted to the plurality of pixel sections.

3. A display apparatus comprising:
a plurality of pixel sections each having a pixel element; and
driver circuit sections that input image display signals to the plurality of pixel sections,
wherein the driver circuit sections generate test signals in accordance with test signals that are inputted from an outside source, and input the test signals thus generated to the plurality of pixel sections.

4. The display apparatus according to claim 1, wherein drive circuits that drive the pixel elements, respectively, and the test terminals are formed on a substrate.

5. The display apparatus according to claim 2, wherein drive circuits that drive the pixel elements, respectively, and the driver circuit sections are formed on a substrate.

6. The display apparatus according to claim 1, wherein the pixel elements that constitute the pixel sections and the drive circuits that drives the pixel elements are formed in a stack structure.

7. The display apparatus according to claim 1, wherein the test signals that are inputted from the outside source are used to cause 25% or more of the pixel elements to perform a display.

8. The display apparatus according to claim 1, wherein the test signals that are inputted from the outside source are used to actuate arrays of the pixel elements at regular intervals.

9. A display system comprising a display apparatus according to claim 1.

10. The display apparatus according to claim 2, wherein drive circuits that drive the pixel elements, respectively, and the test terminals are formed on a substrate.

11. The display apparatus according to claim 3, wherein drive circuits that drive the pixel elements, respectively, and the driver circuit sections are formed on a substrate.

12. The display apparatus according to claim 2, wherein the pixel elements that constitute the pixel sections and the drive circuits that drives the pixel elements are formed in a stack structure.

13. The display apparatus according to claim 3, wherein the pixel elements that constitute the pixel sections and the drive circuits that drives the pixel elements are formed in a stack structure.

14. The display apparatus according to claim 2, wherein the test signals that are inputted from the outside source are used to cause 25% or more of the pixel elements to perform a display.

15. The display apparatus according to claim 3, wherein the test signals that are inputted from the outside source are used to cause 25% or more of the pixel elements to perform a display.

16. The display apparatus according to claim 2, wherein the test signals that are inputted from the outside source are used to actuate arrays of the pixel elements at regular intervals.

17. The display apparatus according to claim 3, wherein the test signals that are inputted from the outside source are used to actuate arrays of the pixel elements at regular intervals.

18. A display system comprising a display apparatus according to claim 2.

19. A display system comprising a display apparatus according to claim 3.
